(19) United States
(12) Patent Application Publication
(10) Pub. No.: US 2025/0267028 A1
(43) Pub. Date: Aug. 21, 2025

(54) METHOD AND APPARATUS FOR PROVIDING MULTICAST AND BROADCAST SERVICE IN NON-TERRESTRIAL NETWORK

(71) Applicant: Electronics and Telecommunications Research Institute, Daejeon (KR)

(72) Inventor: Hee Wook KIM, Daejeon (KR)

(21) Appl. No.: 19/054,658

(22) Filed: Feb. 14, 2025

(30) Foreign Application Priority Data
Feb. 15, 2024 (KR) 10-2024-0022139
Aug. 8, 2024 (KR) 10-2024-0106184
Jan. 17, 2025 (KR) 10-2025-0007569

(51) Int. Cl. H04L 12/18

(52) U.S. Cl. CPC H04L 12/1845; H04L 12/189

(57) ABSTRACT

Disclosed are a method and an apparatus for providing multicast and broadcast services in a non-terrestrial network. A method of an NTN base station may comprise: transmitting, to a terminal, service area information including information on a valid range of a multicast-broadcast service (MBS) for each of a plurality of service areas preconfigured for MBS provision; and transmitting MBS signals for providing the MBS to the terminal.

### CROSS-REFERENCE TO RELATED APPLICATIONS

This application claims priority to Korean Patent Applications No. 10-2024-0022139, filed on Feb. 15, 2024, No. 10-2024-0106184, filed on Aug. 8, 2024, and No. 10-2025-0007569, filed on Jan. 17, 2025, with the Korean Intellectual Property Office (KIPO), the entire contents of which are hereby incorporated by reference.

### BACKGROUND

### 1. Technical Field

The present disclosure relates to a technique for providing multicast and broadcast services in a non-terrestrial network, and more particularly, to a technique for providing multicast and broadcast services to specific areas in a non-terrestrial network using satellites with a large cell radius.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, multicast and broadcast services (MBS) may be services for resource-efficient transmission to multiple users requiring reception of the same content. The NR multimedia broadcast and multicast service (MBS) technologies for efficiently providing such multicast and broadcast services may primarily deliver multicast and broadcast services based on a terrestrial network (TN). Unlike terrestrial networks, non-terrestrial networks (NTNs) can exhibit high mobility characteristics, such as low earth orbit (LEO) satellites, have larger cell coverage areas, experience relatively long propagation delays, and operate in power-constrained environments. Therefore, MBS technologies suitable for non-terrestrial network environments may be required.

### SUMMARY

The present disclosure for resolving the above-described problems is directed to providing a method and an apparatus for providing multicast and broadcast services to specific areas in a non-terrestrial network using satellites with a large cell radius.

A method for providing multicast and broadcast services, performed by a non-terrestrial network (NTN) base station according to a first exemplary embodiment of the present disclosure, may comprise: transmitting, to a terminal, service area information including information on a valid range of a multicast-broadcast service (MBS) for each of a plurality of service areas preconfigured for MBS provision; and transmitting MBS signals for providing the MBS to the terminal.

The service area information may include geographic information indicating a shape of each of the plurality of service areas.

At least one service area among the plurality of service areas may have a circular shape, and the geographic information for the at least one service area may include information on a reference point of the circular shape and distance information from the reference point.

At least one service area among the plurality of service areas may have an elliptical shape or a polygonal shape.

The service area information may include non-geographic information for modeling each of the plurality of service areas.

The non-geographic information may include at least one of a beam index associated with the MBS service, a cell identifier mapped to the MBS service, a tracking area identifier (TAI) associated with the MBS service, a service identifier associated with the MBS service, a temporary mobile group identity (TMGI) associated with the MBS service, a session identifier associated with the MBS service, a group radio network temporary identifier (G-RNTI) associated with the MBS service, an MBS radio bearer (MRB) associated with the MBS service, or a synchronization signal block (SSB) associated with the MBS service.

The service area information may include information on an allowed service area for the MBS service and information on a restricted service area for the MBS service.

The transmitting of the service area information to the terminal may comprise: generating system information including the service area information; and transmitting the system information to the terminal to deliver the service area information to the terminal.

The system information may be at least one of a system information block (SIB) 1, SIB6, SIB7, SIB19, SIB20 or SIB25.

A size of a transmission range of the MBS signals may be larger than a size of a service area corresponding to the service area information.

The method may further comprise, when the NTN base station operates an earth-moving cell, transmitting information on a reference time for each of the plurality of service areas.

A method for providing multicast and broadcast services, performed by a terminal according to a second exemplary embodiment of the present disclosure, may comprise: receiving, from a non-terrestrial network (NTN) base station, service area information including information on a valid range of a multicast-broadcast service (MBS); acquiring a location of the terminal; identifying a service area matching the location based on the service area information; and in response to identifying a service area matching the location, selectively receiving the MBS from the NTN base station by receiving MBS signals associated with the identified service area.

The method may further comprise: in response to not identifying a service area matching the location, not receiving the MBS service.

The method may further comprise: in response to not identifying a service area matching the location, receiving the MBS signals; and not performing decoding of the MBS signals.

The method may further comprise: receiving information on a reference time for each of a plurality of service areas from the NTN base station; and determining a service area after a specific time according to satellite movement using ephemeris information of the NTN base station and the information on the reference time.

The selectively receiving of the MBS comprises: in response to the location being matched to the service area information, starting a multicast radio bearer (MRB) establishment procedure; and in response to the location not being matched to the service area information, releasing an established MRB.

An apparatus for providing multicast and broadcast services, which is a terminal according to a third exemplary embodiment of the present disclosure, may comprise at least one processor, and the at least one processor causes the terminal to perform: receiving, from a non-terrestrial network (NTN) base station, service area information including information on a valid range of a multicast-broadcast service (MBS); acquiring a location of the terminal; identifying a service area matching the location based on the service area information; and in response to identifying a service area matching the location, selectively receiving the MBS from the NTN base station by receiving MBS signals associated with the identified service area.

The at least one processor may further cause the terminal to perform: in response to not identifying a service area matching the location, not receiving the MBS service.

The at least one processor may further cause the terminal to perform: in response to not identifying a service area matching the location, receiving the MBS signals; and not performing decoding of the MBS signals.

The at least one processor may further cause the terminal to perform: receiving information on a reference time for each of a plurality of service areas from the NTN base station; and determining a service area after a specific time according to satellite movement using ephemeris information of the NTN base station and the information on the reference time.

According to the present disclosure, a satellite with a large cell radius can efficiently provide multicast and broadcast services specialized for specific areas, such as by country or region, in a non-terrestrial network. Accordingly, in the non-terrestrial network based on a satellite with a large cell radius, terminals within the cell can receive multicast and broadcast services distinguished by their locations.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating exemplary embodiments of a system supporting 5G MBS.

FIG. 5 is a conceptual diagram illustrating exemplary embodiments of a method for providing multimedia and broadcast services within a terrestrial network cell.

FIG. 6 is a conceptual diagram illustrating exemplary embodiments of a method for providing multimedia and broadcast services within a non-terrestrial network (NTN) cell.

FIG. 7 is a conceptual diagram illustrating exemplary embodiments of delivering information on service areas within a non-terrestrial network (NTN) cell from a base station to a terminal.

FIGS. 8A to 8F are conceptual diagrams illustrating exemplary embodiments of methods for providing geographical information representing service areas.

FIGS. 9A to 9F are conceptual diagrams illustrating exemplary embodiments of methods for providing geographical information representing service areas, including time information.

FIG. 10 is a conceptual diagram illustrating exemplary embodiments of service areas classified into allowed service areas and restricted areas.

FIG. 11 is a conceptual diagram illustrating exemplary embodiments of a method for associating service area information with MBS services.

FIG. 12 is a flowchart illustrating exemplary embodiments of a method for providing multicast and broadcast services in a non-terrestrial network by a base station.

FIG. 13 is a flowchart illustrating exemplary embodiments of a method for providing multicast and broadcast services in a non-terrestrial network by a terminal.

FIG. 14 is a flowchart illustrating exemplary embodiments of a method for providing multicast and broadcast services in a non-terrestrial network by a terminal.

FIG. 15 is a conceptual diagram illustrating examples of a range of a list of intended service areas signaled in a certain cell.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

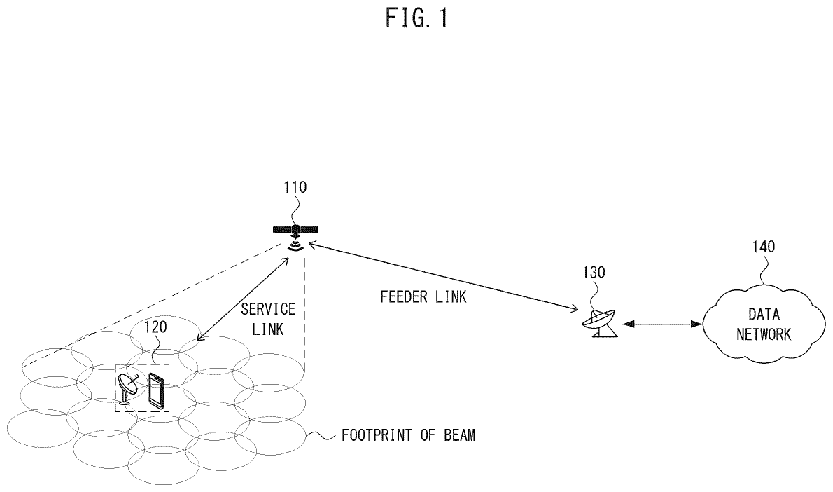

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

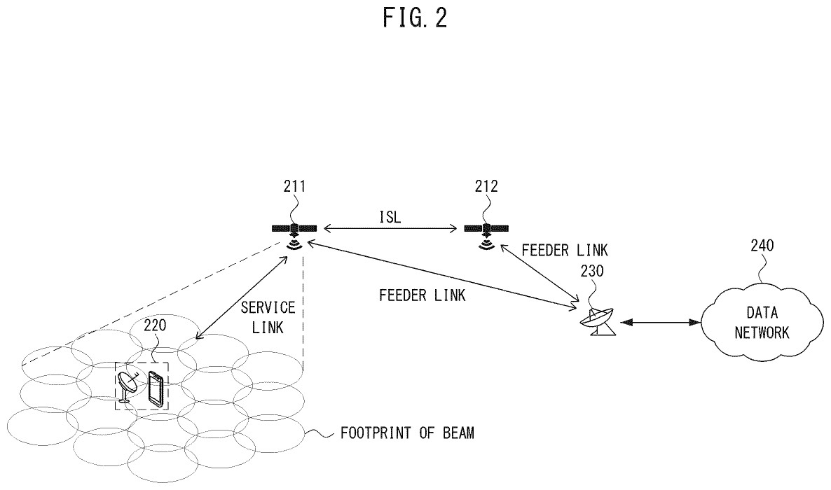

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

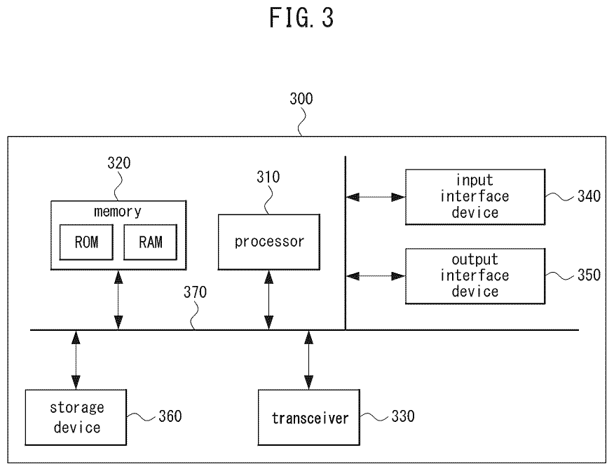

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Maximum channel | 30 MHz for band <6 GHz | | | |
| bandwidth capability | 1 GHz for band >6 GHz | | | |
| (service link) | | | | |
| Maximum distance between | 40,581 | km | 1,932 km (altitude of 600 km) | |
| satellite and communication | | | 3,131 km (altitude of 1,200 km) | |
| node (e.g. UE) at the | | | | |
| minimum elevation angle | | | | |

| Maximum round trip delay | Scenario A: 541.46 ms | | Scenario C: (transparent |
|---|---|---|---|
| (RTD) | (service and feeder links) | | payload: service and feeder |
| (only propagation delay) | Scenario B: 270.73 ms (only | | links) |
| | service link) | | −5.77 ms (altitude of 60 0 km) |
| | | | −41.77 ms (altitude of 1,200 |
| | | | km) |
| | | | Scenario D: (regenerative |
| | | | payload: only service link) |
| | | | −12.89 ms (altitude of 600 |
| | | | km) |
| | | | −20.89 ms (altitude of 1,200 |
| | | | km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |
| within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, a multicast and broadcast service may be a service for resource-efficient transmission to multiple users requiring reception of the same content. Due to the advantage of being able to perform a single transmission to multiple users, the 3rd Generation Partnership Project (3GPP) has introduced a multimedia broadcast/multicast service (MBMS) technique in wideband code division multiple access (WCDMA)-based 3rd generation (3G) standards to efficiently provide multimedia services over cellular mobile communication networks.

The MBMS technique can support a wider coverage area than mobile communication technologies based on unicast transmission in a cellular environment and can deliver the same data to multiple users through the same physical resources, making it significantly different from conventional mobile communication transmission technologies.

The MBMS technique has been first standardized in the WCDMA-based Release 6 (Rel-6) 3G specifications and has been introduced to efficiently provide mobile television (TV) services through 3G mobile communication networks. However, the MBMS technique may not have provided satisfactory performance due to the difficulty of efficiently processing the increased multipath channel effects caused by a multicast broadcast single frequency network (MBSFN) using a RAKE receiver. Additionally, at that time, media consumption through mobile devices was relatively low, and as a result, the MBMS technique did not attract significant attention.

Subsequently, from around 2008, the 3GPP has begun full-scale standardization of long-term evolution (LTE) based on orthogonal frequency division multiplexing (OFDM) technology. Consequently, driven by LTE broadband services, media demand through mobile devices gradually increased, and in Release 9 (Rel-9), the standardization of MBMS technique based on LTE has been carried out. As a result, evolved MBMS (eMBMS) technique has been standardized to leverage LTE's wide bandwidth to support high transmission rates and to efficiently enable MBSFN configuration by adjusting a cyclic prefix (CP) of OFDM.

Following the introduction of eMBMS technique, efforts to improve MBMS service functionality continued from Release 10 (Rel-10) to Release 13 (Rel-13) over several years. First, in Release 10, to efficiently operate MBSFN, MBMS transmission has been adjusted based on the distribution of terminals receiving MBMS services, and a function to dynamically adjust the MBMS service area has been added. Subsequently, in Release 11 (Rel-11), enhancements have been made to improve MBMS service continuity and quality in inter-cell handover scenarios and in LTE multi-frequency networks.

In Release 12 (Rel-12), improvements to MBMS services focused on utilizing terminal feedback information, and a function called ‘MBMS operation on demand (MOOD)’ has been introduced to activate or deactivate MBMS based on feedback. In Release 13 (Rel-13), separately from previous efforts to improve MBSFN operation efficiency, mobile network operators sought efficient coexistence of MBMS transmission and unicast transmission within a single cell. As a result, single-cell point-to-multipoint (SC-PTM) technique has been incorporated into the MBMS technique. From this point on, MBMS transmission has been able to apply various functions used by unicast transmission within a single cell.

Subsequently, with the initiation of 5th generation (5G) standardization around Release 15 (Rel-15), various requirements for 5G technology have been defined. As part of these, requirements for 5G broadcasting have been also established. In particular, the 3GPP included conditions in the 5G broadcast requirements not only to support linear broadcasting services with wide coverage, such as terrestrial broadcasting services, but also to enable efficient coexistence with unicast transmission in narrow service areas and allow dynamic modifications. Based on these requirements, the 3GPP has incorporated 5G multicast and broadcast service (5G MBS) techniques into the Release 17 (Rel-17) specification standardization.

Meanwhile, New Radio (NR) MBS technologies for efficiently providing multicast and broadcast services can mainly provide multicast and broadcast services based on terrestrial networks (TN). Unlike terrestrial networks, non-terrestrial networks (NTN), such as low Earth orbit (LEO) satellites, may exhibit characteristics of high-speed mobility, have large cell coverage, experience relatively long propagation delays, and operate in power-constrained environments. Therefore, it may be necessary to analyze the feasibility of applying NR MBS technologies in a non-terrestrial network environment.

The present disclosure is intended to address the aforementioned issues of conventional technologies and aims to efficiently provide specialized multicast and broadcast services in specific areas, such as country-based or region-based services, while minimizing the impact of existing TN and NTN specifications and technologies in non-terrestrial networks utilizing geostationary Earth orbit (GEO) and LEO satellites, which have large cell coverage.

The present disclosure aims to address the aforementioned issues of conventional technologies by providing an apparatus and method for multicast and broadcast service provisioning in a non-terrestrial network (NTN), such as a satellite-based NTN using GEO and LEO satellites, which can distinguish multicast and broadcast services receivable by terminals within a cell based on their locations.

Meanwhile, the present disclosure described below will describe methods for providing multicast and broadcast services in a non-terrestrial network. Specifically, the present disclosure will describe methods for providing multicast and broadcast services (MBS) efficiently in a non-terrestrial network utilizing GEO and LEO satellites with large cell coverage while minimizing the impact of existing TN and NTN standards and technologies, and specializing services for a specific area, such as country-based or region-based multicast and broadcast services. For MBS broadcast service, the work to any satellite constellation type is not restricted.

In this regard, the 3GPP has been standardizing 5G technology since Release 15 (Rel-15), during which various requirements for 5G technology have been defined. As part of these, requirements for 5G broadcasting have been also established. In particular, the 3GPP included in the 5G broadcast requirements not only support for linear broadcasting services with wide coverage, such as terrestrial broadcasting services, but also conditions that allow efficient coexistence with unicast services in narrow service areas and enable dynamic modifications. Based on these requirements, the 3GPP included 5G MBS technology in the Release 17 (Rel-17) specification standardization.

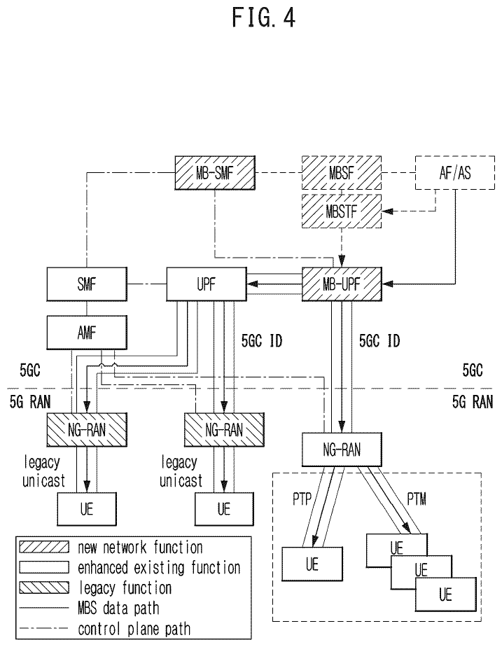

FIG. 4 is a conceptual diagram illustrating exemplary embodiments of a system supporting 5G MBS.

Referring to FIG. 4, the system may include user equipments (UEs), next-generation radio access networks (NG-RANs) each of which corresponds to a base station, an access and mobility management function (AMF) device, a multicast/broadcast user plane function (MB-UPF) device, a multicast/broadcast session management function (MB-SMF) device, a session management function (SMF) device, a multicast/broadcast service function (MBSF) device, a multicast/broadcast service traffic function (MBSTF) device, an application function (AF) device, an application server (AS) device, a user plane function (UPF) device, and the like.

Here, a 5G core network (5GC) may include the AMF, SMF, UPF, MB-UPF, MB-SMF, MBSF, MBSTF, AF/AS, and the like. Additionally, a 5G RAN may include the NG-RANs. The MB-UPF, MB-SMF, MBSF, and MBSTF may be newly added network functions. The AMF, SMF, UPF, AF/AS, some NG-RANs, and UEs may be enhanced existing network functions.

The key features of 5G MBS technology may be as follows.
Introduction of a group scheduling mechanism to allow simultaneous reception of MBS and unicast transmission at terminals
Shared delivery of multicast and broadcast services in the 5G core network
Dynamic service switching between point-to-multipoint (PTM) and point-to-point (PTP) transmission, and enhanced reliability through support for automatic repeat request (ARQ) and hybrid automatic repeat request (HARQ)
Support for service continuity and lossless handover
Reception of broadcast services regardless of the radio resource control (RRC) state of the terminal
Support for MBS services in existing network nodes

From a network architecture perspective, the 5G system network structure has been improved to support MBS services while reusing the legacy 5G system as much as possible. To support 5G MBS, the following new network functions have been introduced.
MB UPF: The MB UPF serves as an entry point to the 5G system (5GS) and may function as a session anchor for the 5GS.
MB SMF: The MB SMF may be an MBS session management and user plane function based on policy rules for multicast and broadcast services.
MBSF: The MBSF may support service-level functions interacting with the application function (AF) or application server (AS) and the MB SMF for MBS session operations.
MBSTF: The MBSTF may serve as a media anchor for MBS data traffic and may support general packet transmission functions available in IP multicast-supported applications, such as framing, multiple flows, and packet encoding.

With the newly added network functions and enhanced existing network functions, the 5GC can support two types of delivery schemes to transmit MBS data traffic from the MB-UPF to the NG-RAN: shared MBS traffic delivery (SD) and individual MBS traffic delivery (ID).

The SD delivery scheme may be used to conserve 5GC resources for MBS data transmission. In the SD delivery scheme, when the MB-UPF has packets to transmit to multiple terminals receiving an MBS session's data, the MB-UPF may transmit a single copy of the MBS data packet to each NG-RAN node. This single-copy packet may not be dedicated to a single terminal and may be shared among multiple terminals. In contrast, in the ID delivery scheme, when the MB-UPF has packets to transmit to multiple terminals receiving an MBS session's data, the MB-UPF may deliver a single copy of the MBS data packet to the UPF. The UPF may then separate and transmit individual copies to each terminal. The ID delivery scheme may not be resource-efficient. However, it may be a necessary scheme when an NR-RAN node does not support MBS functionality but still needs to transmit data for the MBS session.

From a protocol perspective, 5G MBS technology has enhanced the existing NR protocol to support both multicast and broadcast services, which have different characteristics. The target service of the multicast mode may have specific quality of service (QOS) requirements that need to be guaranteed by the network, similarly to unicast transmission.

Therefore, the terminal receiving multicast data may be in the RRC connected state. Using dedicated RRC signaling, radio resource configurations, such as MBS radio bearer (MRB) configuration and physical layer configuration, and may be provided based on interactions between the terminal and the base station. Additionally, if reliable transmission is required for cell edge users, the transmission may be switched from PTM transmission to PTP transmission.

If multicast data is not arriving, the multicast session may be deactivated, and terminals belonging to a multicast group may transition to the inactive or idle state. When the multicast session is reactivated, these terminals may transition back to the connected state.

In contrast, the broadcast mode may be provided to all users within a coverage area regardless of their RRC states. The broadcast mode may use a mechanism similar to single-cell point-to-multipoint (SC-PTM) in LTE. To deliver broadcast data to terminals outside of the connected state, a MBS control channel (MCCH) may periodically transmit the radio resource configuration for the broadcast mode. Terminals may then apply this configuration to a MBS traffic channel. The broadcast mode may not require interaction between the terminal and the base station. As a result, the network does not receive feedback on transmission status from terminals and transmits data in a best-effort manner.

To support both multicast and broadcast modes with the characteristics described above, the existing NR protocol may be improved as follows.
Service Data Adaptation Protocol (SDAP) layer: For MBS support, the RAN may newly define the MBS radio bearer (MRB). The SDAP layer may provide a one-to-one mapping between an MBS session and an MRB to serve multiple MBS QOS flows (QOS Flow, QF) based on the required QoS and network policy. Since MBS exists only for downlink transmission, uplink SDAP functions such as reflective QoS and network-initiated QF remapping may not be supported.
Packet Data Convergence Protocol (PDCP) layer: The PDCP for MBS may differ from the PDCP for unicast services. In the PDCP for MBS, a PDCP entity may support a split MRB that connects to one point-to-multipoint radio link control (PTM RLC) and one point-to-point RLC (PTP RLC). Through this, the base station may transmit MBS packets via the PTP RLC, the PTM RLC, or both RLCs according to the reliability requirements. When the base station transmits the same sequence of PDCP packets through both RLCs, the terminal may discard the later-arriving packets using a PDCP duplicate detection function.
RLC layer: The RLC may support PTP RLC and PTM RLC. The PTM RLC may be a group-common RLC. All terminals configured to use the PTM RLC may receive the same packet using a group radio network temporary identifier (G-RNTI) or group-configured scheduling RNTI (G-CS-RNTI). Due to the synchronization complexity between multiple terminals and base stations for PTM RLC entities, the PTM RLC may not support acknowledged mode (AM) and may operate in unacknowledged mode (UM). In contrast, the PTP RLC may be a dedicated RLC for each terminal. In the PTP RLC, packets may be transmitted only to a specific terminal using a cell RNTI (C-RNTI) or configured scheduling RNTI (CS-RNTI). The PTP RLC may ensure reliable transmission through ARQ functions. The base station may select an appropriate RLC for packet transmission considering the required reliability, the terminal's link quality, and the cell congestion state.
Medium Access Control (MAC) layer: To reduce the power consumption of terminals, an MBS session-specific discontinuous reception (DRX) may be configured for terminals receiving MBS data. Additionally, the MAC may manage physical layer parameters related to MBS, such as MBS semi-persistent scheduling (SPS) and HARQ. Unlike unicast SPS, which uses CS-RNTI for activation, deactivation, and retransmission, MBS SPS may be controlled by both unicast signaling via CS-RNTI and multicast signaling via G-CS-RNTI.

Finally, improvements from the physical layer perspective have been made primarily in terms of bandwidth part (BWP) operations and HARQ operations. First, from the BWP perspective, the Release 17 specification has introduced a concept of a common frequency resource (CFR) for MBS reception, where multiple terminals can commonly receive MBS, including a group-common physical downlink shared channel (PDSCH) or PDSCH.

The MBS CFR may be classified into multicast CFR and broadcast CFR. The multicast CFR may be defined within a dedicated active unicast BWP of a terminal to support simultaneous reception of unicast and multicast in the same time slot. The sub-carrier spacing (SCS) and cyclic prefix (CP) in CFR may have the same values as those of the active unicast BWP to avoid BWP switching. In contrast, the broadcast CFR may be defined within the initial BWP. Next, from the HARQ operation perspective, unlike LTE eMBMS or SC-PTM, HARQ-ARQ feedback and HARQ retransmission may flexibly support the following three options for high-reliability transmission in multicast mode.
Positive acknowledgment (ACK)/negative acknowledgment (NACK)-based HARQ-ACK feedback: A terminal may provide ACK or NACK feedback using a dedicated physical uplink control channel (PUCCH) resource of the terminal. This scheme may be effective for a small number of terminals receiving multicast data.
NACK-based HARQ-ACK feedback: A terminal may provide only NACK feedback using a common PUCCH resource shared among other terminals within the same group. This scheme may be resource-efficient. However, the base station may not detect a case where terminals fail to decode physical downlink control channel (PDCCH) information.
No HARQ-ARQ feedback applied: A terminal may not transmit any feedback for the received data. When the QoS requirements for multicast data are low, the base station may use this scheme to reduce resource consumption.

The base station may dynamically switch between ACK/NACK-based HARQ-ACK feedback and no feedback mode via RRC signaling or downlink control information (DCI). Finally, NR MBS has improved existing NR technology to support mobility and service continuity. Unlike previous generations, where mobility and service continuity were supported at the RAN level, NR MBS supports packet-level lossless mobility, minimizing the impact on existing RAN protocols. The applied packet-level service continuity may be based on packet-level sequence number synchronization, where the same packet retains the same PDCP sequence number within an area supporting service continuity. This packet number synchronization may allow terminals to naturally maintain the configured MRB during handover.

The NR MBS technologies with the above-described characteristics may primarily provide multicast and broadcast services based on terrestrial mobile communication networks. Non-terrestrial networks (NTN), unlike terrestrial networks, may have high-speed mobility characteristics, such as LEO satellites, large cell coverage, relatively long propagation delay, and may operate in power-constrained environments. Therefore, it may be necessary to analyze the feasibility of applying NR MBS technologies in non-terrestrial network environments.

The 5G NTN standardization aims to minimize the impact on existing TN specifications while defining the minimum necessary standards for NTN operations. Considering this, 5G NTN technologies for efficient multimedia and broadcast service provisioning may focus on maximizing the reuse of technologies applied in existing TN rather than introducing NTN-optimized technologies, with improvements mainly made to parts that require modification or addition due to the NTN-specific environment.

First, aspects related to modifications or removals necessary to apply basic NR MBS technology to NTN will be examined. Most of the above technologies considered in 5G NR MBS for TN may be applicable to 5G NTN MBS without modification. On the other hand, additional improvements may be needed, such as modifying protocol layer timer parameter values to account for long propagation delays. However, such modifications may follow the same approach used in Release 17 and Release 18, where existing NR protocol parameter values were adjusted due to long propagation delays.

Next, aspects that need to be newly added for NTN MBS beyond existing NR MBS technology will be examined. In 5G NR MBS, a multicast or broadcast service area may be considered as the entire coverage area of a single RAN node. Since the coverage of a single RAN node is relatively small compared to NTN, the multicast and broadcast service area may be distinguished at the RAN node coverage area level. Based on this assumption, distinguishing multicast and broadcast service areas within a RAN node may not be necessary. However, unlike TN, NTN may have a cell coverage of 100 km or more, reaching over 1000 km. As a result, a single NTN cell may include multiple regional or national regions. Due to the nature of broadcast and multicast services, it may be necessary to provide separately managed services per country or region. Considering regulatory aspects and emergency service provisioning, a method for distinguishing multicast and broadcast service areas within the coverage of a single RAN node in NTN may need to be newly introduced, unlike in TN.

To address these issues, the present disclosure proposes techniques for efficiently providing multicast and broadcast services specialized for specific areas, such as country-based or region-based services, in an NTN utilizing GEO and LEO satellites with large cell coverage, while minimizing the impact of existing TN technology specifications.

Specifically, the present disclosure proposes methods that allow determining whether a terminal can receive a multicast or broadcast service based not only on a group ID but also on the terminal's location, in order to efficiently provide multicast and broadcast services specialized for specific areas, such as country-based or region-based services, in an NTN utilizing GEO and LEO satellites with large cell coverage, while minimizing the impact of existing TN and NTN specifications and technologies.

A preferred exemplary embodiment of the present disclosure will be described in detail below. The following exemplary embodiment will describe the present disclosure assuming an NR-based satellite mobile communication system. However, the method disclosed in the present disclosure may be widely applicable to any other mobile communication system with a large cell coverage area.

According to an exemplary embodiment of the present disclosure, a terminal may receive MBS communication within a service area. For example, a terminal may receive MBS communication from an NTN cell. For example, a terminal may receive MBS communication from a TN cell. For example, a terminal may receive MBS communication from both a TN cell and an NTN cell. For example, a network entity forming a TN cell or an NTN cell may apply a delay offset to MBS communication. Accordingly, a UE may simultaneously receive MBS communication from each network entity (TN/NTN). In addition, MBS communication may include MCCH data, multicast traffic channel (MTCH) data, or both. For example, MTCH data may be encrypted, whereas MCCH data may not be encrypted. A terminal may use a decryption key to decode the MTCH data.

As an example, a network entity (satellite) may encrypt MBS communication and transmit the encrypted MBS communication via an NTN cell. For example, a terminal may be located within a service area. In this case, the network entity (satellite) may provide the terminal with a decryption key related to the encrypted MBS communication. The terminal within the service area may use the received decryption key to decode the encrypted MBS communication. Terminals outside the service area may not be able to decode the encrypted MBS communication.

More specifically, a broadcast communication service can be delivered to a terminal through a broadcast session. A terminal can receive a broadcast communication service in RRC_IDLE, RRC_INACTIVE, and RRC_CONNECTED states. In the case of a broadcast communication service, the same service and the same specific content data can be provided simultaneously to all terminals within a designated geographical area. All terminals within the broadcast service area as defined in TS 23.247, or all terminals within the intended service area connected to an NTN supporting MBS broadcast, may be authorized to receive the data.

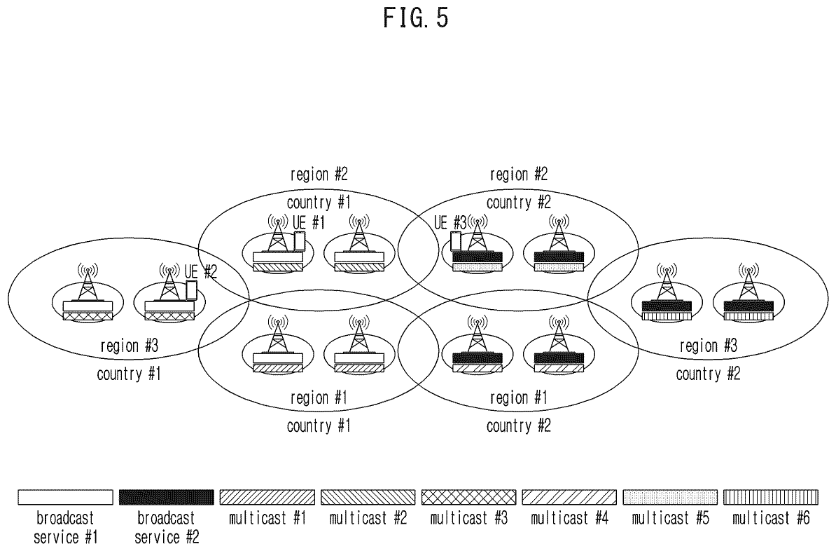

FIG. 5 is a conceptual diagram illustrating exemplary embodiments of a method for providing multimedia and broadcast services within a terrestrial network cell.

Referring to FIG. 5, in the case of TN, the coverage of a base station may be relatively small compared to the area of each region or country. Therefore, multiple base stations may provide multicast and broadcast services within a single region or a single country. In this TN scenario, multiple base stations deployed within a given country or region may distinguish the broadcast and multicast services provided by each base station to facilitate the provisioning of country-specific or region-specific broadcast and multicast services.

For example, multiple base stations may provide (broadcast) a broadcast service #1 in a country #1. Multiple base stations may provide (broadcast) a broadcast service #2 in a country #2. In this case, multiple base stations deployed in the country #1 may provide the broadcast service #1, and multiple base stations deployed in the country #2 may provide the broadcast service #2. As such, multiple base stations may provide broadcast services separately by country. When a specific terminal (UE #1 or UE #2) is located in the country #1, the terminal is connected to a base station deployed in the country #1, making it naturally impossible to receive the broadcast service #2, which is provided outside the coverage area. When a specific terminal (UE #3) is located in the country #2, the terminal is connected to a base station deployed in the country #2, making it naturally impossible to receive the broadcast service #1, which is provided outside the coverage area.

Additionally, multiple base stations may provide (broadcast) a multicast #1 in a region #1 of the country #1. Multiple base stations may provide (broadcast) a multicast #2 in a region #2 of the country #1. Multiple base stations may provide (broadcast) a multicast #3 in a region #3 of the country #1. Multiple base stations may provide (broadcast) a multicast #4 in a region #1 of the country #2. Multiple base stations may provide (broadcast) a multicast #5 in a region #2 of the country #2. Multiple base stations may provide (broadcast) a multicast #6 in a region #3 of the country #2.

As such, multiple base stations may provide multicast services separately by country and region. A specific terminal 1 may be located in the region #2 of the country #1. In this case, the terminal 1 is connected to a base station deployed in the region #2 of the country #1, making it naturally impossible to receive the multicast #1, and multicast #3 to multicast #6, which are provided outside the coverage area. A specific terminal 2 may be located in the region #3 of the country #1. In this case, the terminal 2 is connected to a base station deployed in the region #3 of the country #1, making it naturally impossible to receive the multicast #1, multicast #2, and multicast #4 to multicast #6, which are provided outside the coverage area. A specific terminal 3 may be located in the region #2 of the country #2. In this case, the terminal 3 is connected to a base station deployed in the region #2 of the country #2, making it naturally impossible to receive the multicast #1 to multicast #4 and multicast #6, which are provided outside the coverage area. That is, in a TN environment, a base station deployed in a specific region may provide services to terminals located in a specific country or a specific region. Therefore, the services that a terminal located in a specific country or region may receive may be easily limited.

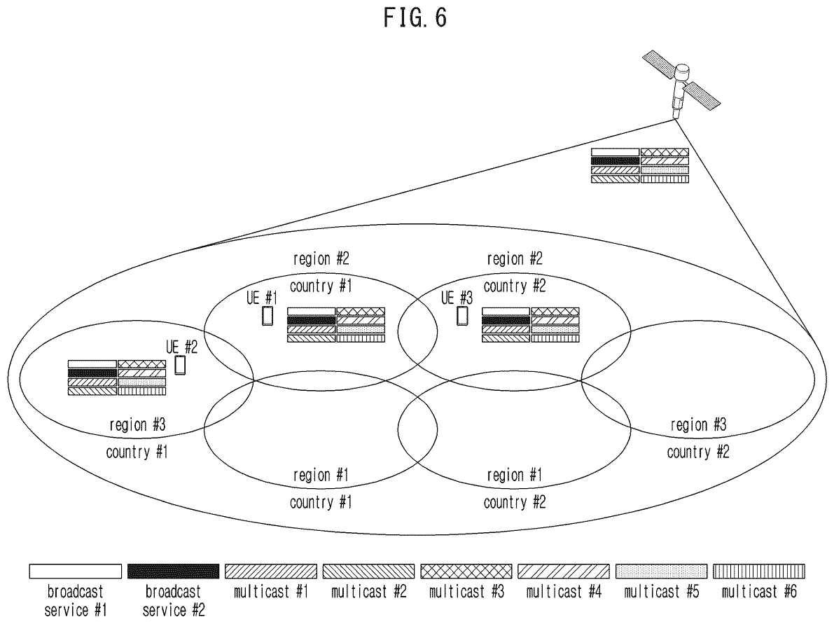

FIG. 6 is a conceptual diagram illustrating exemplary embodiments of a method for providing multimedia and broadcast services within a non-terrestrial network (NTN) cell.

Referring to FIG. 6, in an NTN scenario, LTE MBMS or NR MBS of an existing TN may be transmitted so that all terminals within a service area can receive all services provided by a single RAN node. Accordingly, coverage of an NTN cell may be configured across multiple countries or across multiple regions. Therefore, it is not possible to limit the broadcast and multimedia services that a terminal in a specific region can receive.

For example, in FIG. 5, a TN terminal 1 (UE #1) cannot receive any service other than the broadcast and multicast services of the country #1 and the broadcast and multicast services of the region #2. However, as shown in FIG. 6, in the case of NTN terminal 1 (UE #1), even when located in the country #1, if a factor enabling the reception of the multicast and broadcast services (e.g. G-RNTI) is configured, the broadcast and multicast services of the country #1 may be received, and even when located in the region #2, the broadcast and multicast services of other regions, such as the region #1 and the region #3, may also be provided. This may mean that it is not possible to restrict services by country or region, which may lead to a problem. Therefore, in an NTN environment, a solution to address this issue differently from the TN environment may be additionally required.

System information (e.g. SIB) may be used to ensure service continuity of an MBS session when a terminal initiates a cell reselection procedure. When a terminal performs cell reselection, the terminal may prioritize selecting an MBS frequency on which an MBS session of interest is provided. By providing an intended service area for each MBS frequency in system information, the terminal may accurately determine the intended service area in which a specific frequency provides the desired MBS session. Therefore, during cell reselection, prioritizing an MBS frequency based on the terminal's location and the intended service area for each MBS frequency may be beneficial. The terminal may select an MBS frequency with the highest priority based on the terminal's location and the intended service area for each MBS frequency provided through system information (e.g. SIB2) during cell reselection.

The present disclosure will cover at least the case where the indicated intended service area covers a portion of a NTN cell. The intended service area can cover the area of more than one NTN cells (or portions thereof). At least the following geographical area formats to model service area can be further considered (the signaling of other information than the geographical information can be considered):
Circles (like for TN coverage)
Geographical area information, e.g. via polygons, to better approximate the intended shape of service area

For MBS broadcast service, both EFC ((Earth Fixed Cell) and EMC (Earth Moving Cell) are supported. MBS broadcast intended service area is provided via system information. For MBS broadcast considers the following possibilities for including the service area information: SIB20/SIB21/MBSBroadcastConfiguration. When intended service area (e.g., geographical area/TN coverage) is provided for MBS broadcast service, it needs to be associated with MBS session.

The intended broadcast service area is defined by a geographical area represented by a (set of) referenceLocation and radius or by a (set of) polygon(s). The expected UE behavior is that when the UE is not in any intended service area of its interested broadcast services, the UE may not need to (re) acquire up-to-date MCCH.

For an MBS broadcast service intended for a certain area, a UE supporting the feature should not establish MRB (MBS Radio Bearer) (s) for the MBS session associated to the intended area when it is outside the intended area. For an MBS broadcast service intended for a certain area, a UE supporting the feature may initiate the broadcast MRB establishment procedure when UE is inside the intended area; the UE may initiate the broadcast MRB release procedure when UE leaves the intended area.

For each MBS service, one or more intended service area IDs may be included into MCCH. The list of the intended service areas (and related IDs) is also included in MCCH or if it is provided in a new or existing SIB. The present disclosure will consider possible enhancements (including enhancements left up to UE implementation) to allow UE skipping MCCH re-acquisition when UE is not within intended service area of any interested broadcast service.

The encoding of TN coverage includes tn-ReferenceLocation-r18 and tn-DistanceRadius-r18, is reused for the geographical area of the circle. The encoding of Polygon is reused for the geographical area of the Polygon. The IntendedServiceArea is considered as the IE name of the geographical area. A signaled intended service area for a MBS BC service may include geographic areas across the current serving cell and overlapping neighbour cell(s). The geographic area information for the intended service areas can be semi-static and not cause frequent updates. A new SIB may be introduced to include a list of intended service areas and related pointer. The intended services areas may be pointed via the index in the list or with an ID or another way. The legacy SIB modification procedure may be applied to update the intended service area information in the new SIB.

Area information may be represented by a set of reference locations and radii corresponding thereto or a set of polygons. If the signaling overhead is large and the information is repeatedly used in multiple locations, it may be inefficient. From this perspective, the area information may be defined in a new SIB or an existing SIB, and an area ID may be assigned to each area. This allows locations requiring area information to simply refer to the corresponding area ID, significantly reducing signaling overhead compared to signaling the entire area definition.

The intended service area (composed of one or more circles or polygons) may be defined in a new or existing SIB, and each area may be linked with an area ID. This enables locations requiring service area information to include only the corresponding area ID. Each area may be linked with an area index. Using index is smaller data size and simple lookup mechanism. But using index is dependency on the list order and no global uniqueness.

If the entire geographical intended service areas are not indicated via a new SIB in a certain cell, the list of the intended service areas may need to be frequently updated, particularly when the cell is an EMC (Emergency Communication). Additionally, the intended service area information may be provided via NAS (Non-Access Stratum) signaling as well as AS (Access Stratum) signaling. In such cases, the use of a unique identifier can provide more flexibility in handling references across different cells/networks. An ID-based approach would be a more suitable way to point the intended service areas.

Even if a broadcast service is added or released, system information may remain unchanged. The RAN node may update the system information when a new broadcast service starts (in this case, the most significant bit(s) (MSB(s)) of an MCCH change notification in MBS DCI indicates addition of a session). The intended service area of the newly added broadcast service session may be added to a list.

Another solution involves including association information in the MCCH. This method is simpler to signal than using system information and may loosen an association between MCCH and SIB. That is, an MCCH update may not trigger a system information update. However, changes in the intended service area may cause MCCH modifications, so the terminal may always perform MCCH acquisition and re-acquisition if interested in a broadcast session. Until the MCCH is updated, the terminal may not know whether itself is within the intended service area of the interested broadcast service session.

An enhancement to skip MCCH monitoring when the terminal is not within the intended service area of the interested broadcast service may include the following.

Alternative 1: Use MCCH modification notification (DCI) to indicate an update to the intended service area.

The terminal may be configured to re-acquire the MCCH only when the MCCH modification notification DCI indicates an intended service area update.

Alternative 2: Set a larger modification periodicity for updates to the intended service area of the broadcast service.

The service area modification periodicity may consist of multiple MCCH modification periodicity. Therefore, if the terminal is not within the intended service area, the terminal may not need to re-acquire the MCCH within the service area modification period.

In both alternatives, when a new broadcast session is added, the terminal may always re-acquire the MCCH. The service continuity of MBS may be improved in two aspects.
Provision of neighbor cell information:

A serving base station may provide a list of neighboring cells offering the same MBS broadcast service as the current cell in the MCCH. This allows the terminal to request the service via unicast before moving to a cell that does not provide an MBS broadcast service based on PTM transmission.
Support for MBS frequency layer priority:

The NR MBS may provide an MBS frequency selection assistance ID (FSAI) for an MBS broadcast session with respect to each frequency (including same and different frequencies). By adding the concept of the intended service area, the base station may further enhance service continuity.

As a specific enhancement, the neighboring cell configuration may provide relevant intended service areas within neighboring cells for each broadcast service session. During cell reselection, the terminal may need to determine a frequency priority based on whether the interested MBS broadcast service is provided at the current location on the respective frequency. To support this, system information (e.g. SIB) may provide the intended service area for each frequency for each MBS broadcast service.

The system information may provide a list of FSAIs for each frequency (including same and different frequencies). The terminal may derive mapping between TMGI (temporary mobile group identity) and frequency using mapping between TMGI and FSAI in a user service description (USD) and mapping between frequency and FSAI in SIB21.

### Association Between FSA and MBS Broadcast Services

Case 1: FSAI #x->Single MBS Broadcast Session

In this case, the FSAI is clearly associated with a single MBS broadcast session, so the intended service area may be simply provided for each FSAI.

Case 2: FSAI #x->Multiple MBS Broadcast Sessions

In this case, it may be necessary to explicitly indicate the MBS broadcast service sessions and their respective intended service areas for each FSA.

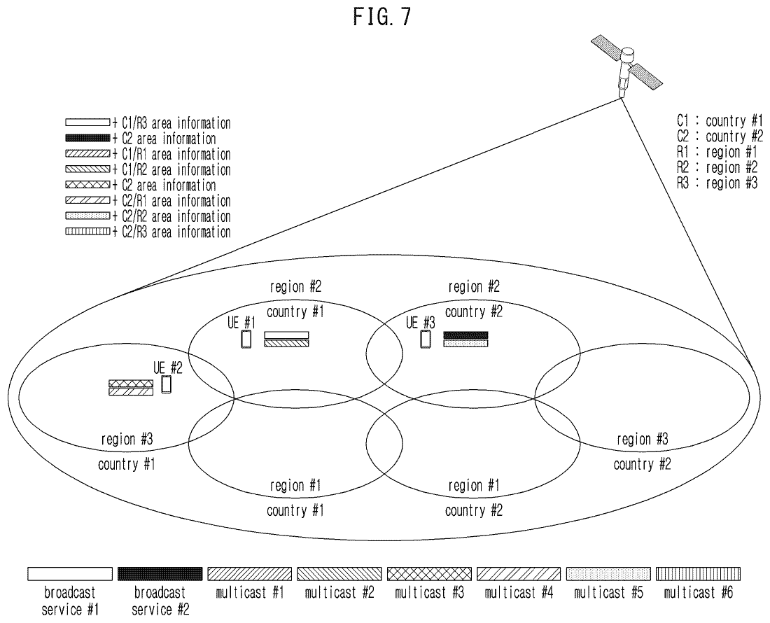

FIG. 7 is a conceptual diagram illustrating exemplary embodiments of delivering information on service areas within a non-terrestrial network (NTN) cell from a base station to a terminal.

Referring to FIG. 7, in a method of providing multicast and broadcast services in a non-terrestrial network, a base station may notify the terminal of information regarding an area where each multicast and broadcast service can be received to address the aforementioned issues. Accordingly, even when a terminal is equipped with parameters (e.g. G-RNTI) that allow itself to receive a service, the base station may restrict access to the multicast and broadcast services if the terminal is not located within the corresponding area (service area).

This location-based selective MBS provision method may be applied without significantly impacting the NTN specifications, as NTN terminals are typically equipped with capability to mandatorily estimate their own locations.

In other words, when a satellite RAN node provides information on multicast and broadcast services, it may additionally inform the terminal of a valid range of each multicast and broadcast service. The terminal may verify whether itself is within the valid range of the service based on its location. Subsequently, the terminal may operate to receive the service only when itself is within the valid range.

For example, as shown in FIG. 7, a terminal 1 (i.e. UE #1) may receive parameters (e.g. G-RNTI) from a satellite RAN node providing two broadcast services and six multicast services, allowing it to access these services. According to the existing TN specifications, the terminal 1 may be able to receive all two broadcast services and six multicast services provided by the satellite RAN node. However, based on the location-aware selective MBS provision method of the present disclosure, the terminal 1 may acquire (or estimate) its location via a global navigation satellite system (GNSS) or similar means. The terminal 1 may identify the service area corresponding to its location (i.e. the valid area of each service provided by the satellite RAN node). Based thereon, the terminal 1 may selectively receive only the broadcast service #1 for country #1 and the multicast service #2 for region #2.

In summary, the base station of the non-terrestrial network according to the present disclosure may transmit MBS transmission signals for MBS service provision to the terminal. In addition, the base station may transmit service area information including the valid ranges of MBS services to the terminal for each of the multiple pre-configured service areas for MBS service provision.

Meanwhile, the present disclosure considers three scenarios related to a service area representing a valid range of MBS service and a coverage area of MBS transmission signals for MBS service provision.

First, in a scenario 1 (S1), a service area (intended service area) may be a part of an NTN cell or multiple cells. In this scenario, the base station may deliver MBS transmission signals (MBS service contents) to the terminal only within the service area. In a scenario 2 (S2), a service area may also be a part of an NTN cell or multiple cells. However, in this scenario, the base station may deliver MBS transmission signals (MBS service contents) to the terminal even outside the service area. In a scenario 3 (S3), a service area may be configured with a list of NTN cells or tracking areas.

In this regard, in the scenario 1 (S1), a service area may coincide with a satellite's beam footprint. This situation may occur, for example, when a beam coverage of the service area is relatively large. Considering this scenario 1 (S1), different MBS sessions may be associated with different geographical areas. Information for such associations may be delivered to the terminal through an SIB, or the like. Furthermore, the scenario 3 (S3) is expected to be supported through existing NR specifications for broadcast service support in terrestrial networks. The MBS provision method in the non-terrestrial network of the present disclosure is preferably performed for the scenarios S1 and S2.

Meanwhile, in the scenario 1 (S1), multiple dedicated physical beams may be required for the respective service areas within a single cell. These beams may have flexible patterns that accommodate various forms of service areas. However, this may be challenging to implement in actual satellite systems, particularly in systems with earth-moving cells. Nevertheless, the multicast and broadcast service provision method in the non-terrestrial network of the present disclosure is more preferably applied targeting the scenario 2 (S2), but it is not limited thereto.

According to the scenario 2 (S2), the coverage area of the MBS transmission signals may be configured larger than the service area corresponding to the service area information. Specifically, the base station of the non-terrestrial network may transmit service area information including the valid range of MBS services to the terminal for each of the multiple pre-configured service areas for MBS service provision.

Additionally, the base station of the non-terrestrial network may transmit MBS transmission signals for MBS service provision to the terminal. Upon receiving such service area information, the terminal may receive MBS services by utilizing the MBS transmission signals linked to the service area information that matches the terminal's location. According to an exemplary embodiment of the present disclosure, the service area information may include geographical area information representing a form of each of the multiple service areas.

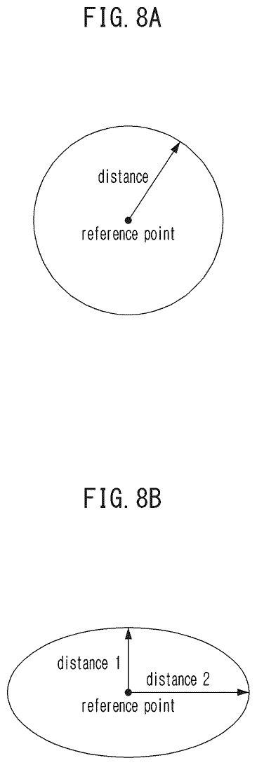

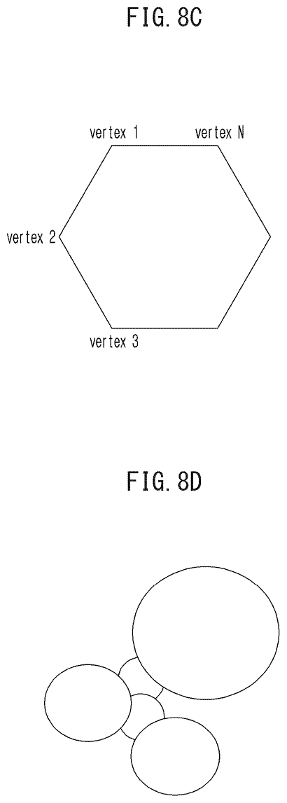

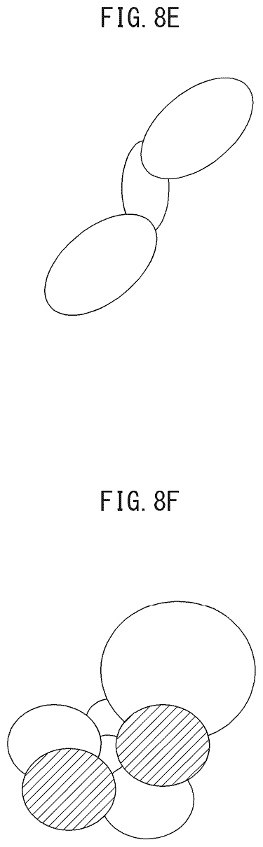

FIGS. 8A to 8F are conceptual diagrams illustrating exemplary embodiments of methods for providing geographical information representing service areas.

Referring to FIG. 8A, a service area may be represented as a circle based on a reference point and distance. Referring to FIG. 8B, a service area may be represented as an ellipse using a reference point and two distances (i.e. distance 1 and distance 2). Referring to FIG. 8C, a service area may be represented as a polygonal shape using point 1 to point N. Here, N may be a positive integer. Referring to FIGS. 8D to 8F, each service area may be represented in a composite manner using different representation schemes.

Referring again to FIG. 8A, at least some of the multiple service areas may have circular shapes. Correspondingly, geographical information representing the shape of the service area may include information on a reference point of a circular shape and distance information from the reference point (e.g. radius information, diameter information, etc.). Meanwhile, regarding the format of geographic information for defining the shape of the service area, the TN coverage encoding method of SIB25, as defined in TS 38.331, can be reused to define a circular (Circle) service area. Specifically, the tn-ReferenceLocation-r18 and tn-DistanceRadius-r18 elements can be used to define the center point and radius of the circular service area, respectively; however, this is not limited to these elements alone.

This scheme (circular representation scheme) requires only two types of information to represent the service area: information on the reference point (e.g. coordinate information) and distance information such as a radius or diameter of the circle. Therefore, it may have the advantage of relatively low signaling overhead. However, it may be difficult to accurately express the shape of the service area. Thus, when the service area does not have a circular shape, it may be challenging to clearly represent the corresponding service area.

In contrast, the elliptical-based service area representation scheme shown in FIG. 8B may provide additional distance information compared to the circular representation scheme. As a result, the signaling overhead may be higher. However, the elliptical-based service area representation scheme may have the advantage of representing the service area more clearly. Specifically, when applying the elliptical-based service area representation scheme, the geographical information for the corresponding service area may include information on the reference point and the first distance (i.e. distance 1) and the second distance (i.e. distance 2) from the reference point.

Additionally, the polygonal-based service area representation scheme shown in FIG. 8C may represent the service area more clearly by depicting it as a polygon composed of multiple vertices. However, this scheme may involve very high signaling overhead. Specifically, when applying the polygonal-based service area representation scheme, the geographical information for the corresponding service area may include information on multiple vertices (e.g. coordinate information for point 1, point 2, . . . , point N). The service area may be defined by connecting the respective vertices. Here, N may be a positive integer. In other words, according to an exemplary embodiment of the present disclosure, at least some of the multiple service areas may have elliptical or polygonal shapes.

Meanwhile, according to an embodiment of the present disclosure, the polygon (Polygon) encoding method defined in TS 37.355 can be reused to define a polygon-shaped service area. For example, the coordinate information of the vertices forming the polygon can be defined using this encoding method. By reusing these encoding methods, various types of service areas can be efficiently defined while maintaining compatibility with existing standards.

In this regard, RAN2 has conducted similar discussions when introducing a new system information block (SIB25) for TN coverage signaling in Release 18 NTN. Defining service areas in circular shapes may reduce signaling overhead. However, defining service areas in circular shapes may have the disadvantage of being less accurate in representing the service areas compared to geographical information-based schemes that define the shapes of the service areas in more detail. Based on the respective advantages and disadvantages in terms of accuracy and signaling overhead, it has been concluded in Release 18 NTN that SIB25 is defined using a coordinates of a reference point (central location) and a radius, providing the corresponding geographical area information through a list of individually defined overlapping areas.

Considering this, a similar approach that applies a circular shape definition scheme (circle-based format) for the shapes of service areas may be similarly applied to the detailed format of service area information for the valid range of MBS services. Furthermore, a similar approach that applies the circular shape definition scheme (circle-based format) may provide an efficient and flexible means of representing various forms of service areas in network implementation by using a list of overlapping circles as the geographical area format of the service area information for MBS services.

In this context, to represent service areas more accurately, a similar approach that applies the circular shape definition scheme (circle-based format) may designate individual circles included in the list of service area information for the valid range of MBS services as either allowed areas or restricted areas.

According to an exemplary embodiment of the present disclosure, the terminal may store information on reference points representing geographical locations or coordinates where it enters from a neighboring region into an international region. When the terminal crosses the reference point(s), the terminal may initiate a distance-tracking process from the reference point(s). In other words, the service area information containing information on the valid ranges of MBS services according to the present disclosure may be defined to include information on at least one reference point representing the boundary of each service area and distance information from the boundary reflecting the size of the corresponding service area.

In this regard, the terminal may retrieve information representing a pre-configured distance from a border (boundary) of country #1 (e.g. ‘country #1’ in FIG. 11). The terminal may receive MBS services from the country #1 while located within that country (or international region). The information representing the pre-configured distance may be received by the terminal from a home Public Land Mobile Network (PLMN) or broadcast from an NTN serving the international region. Alternatively, the pre-configured distance information may be retrieved from the terminal's local database (e.g. Universal Subscriber Identity Module (USIM) external memory, etc.).

In this regard, the terminal may receive MBS services from the country #1 while within the pre-configured distance from the reference point. The terminal may move beyond the pre-configured distance from the reference point. In such cases, the terminal may determine that it has exited the country #1. Consequently, the terminal may re-acquire MBS service area information to receive other higher-priority MBS services in the international region.

Meanwhile, FIGS. 8D to 8F illustrate hybrid representation schemes. FIG. 8D illustrates a scheme of representing a service area using multiple circles of different sizes. FIG. 8E illustrates a scheme of representing a service area using multiple ellipses of different sizes. FIG. 8F illustrates a scheme of representing a service area using multiple circles of different sizes, as shown in FIG. 8D. However, FIG. 8F may illustrate a scheme of distinguishing between allowed areas and restricted areas (slashed circle) for MBS services. In other words, according to an exemplary embodiment of the present disclosure, the service area information may include both allowed area information and restricted area information for MBS services.

From a signaling overhead perspective, the scheme of representing geographical information for service areas in circular forms may be the simplest. Furthermore, the scheme of representing geographical information for service areas in circular forms may utilize part of NTN configuration information format (e.g. NTN_config) available in the existing NTN SIB19.

Meanwhile, considering signaling overhead, the schemes illustrated in FIGS. 8D and 8F may be similarly applied using existing SIBs. In FIG. 8F, the allowed and restricted areas may be distinguished by adding data (e.g. additional 1-bit data) indicating the type of the corresponding area to the service area information, but this is not limited thereto.

The geographical information-based service area representation schemes described with reference to FIGS. 8A to 8F may be applicable to earth-fixed satellites with reference points (reference points) that do not change in the service areas. In earth-moving cells, satellite cells may continuously move. In such cases, time information related to the corresponding service area may be additionally included along with the existing service area information provided by earth-moving cells.

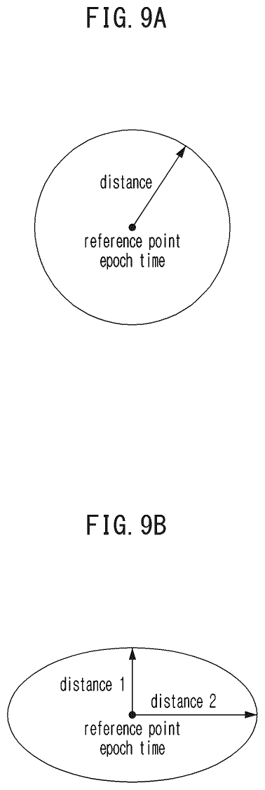

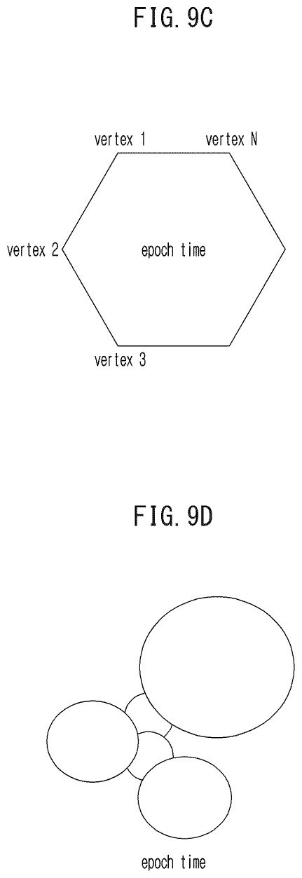

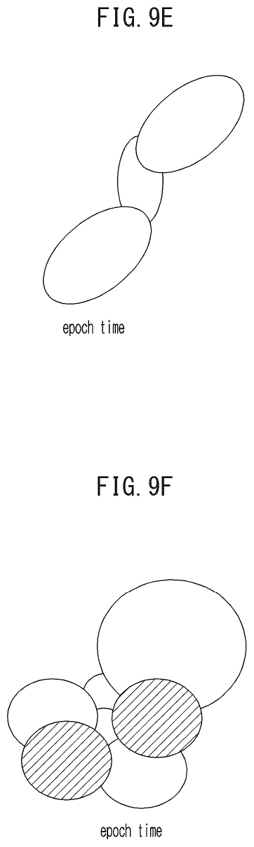

FIGS. 9A to 9F are conceptual diagrams illustrating exemplary embodiments of methods for providing geographical information representing service areas, including time information.

Referring to FIGS. 9A to 9F, a base station of a non-terrestrial network may form earth-moving cells. In this case, the base station may transmit time information referencing the corresponding service area along with the service area information to the terminal. For example, referring to FIGS. 9A to 9F, the time information referencing the service area may refer to epoch time, but is not limited thereto.

In this regard, a terminal that receives service area information including reference time information from the base station forming the earth-moving cell may identify movement of the service area according to an actual satellite movement using the reference time information. More specifically, according to an exemplary embodiment, the terminal may calculate information on the service area after a predetermined time elapses based on ephemeris information acquired from SIB19, corresponding to the movement of the satellite related to the base station.

In other words, according to an embodiment of the present disclosure, the MBS broadcast service can be supported in NTN for both EFC (Earth Fixed Cell) and EMC (Earth Moving Cell). For location-dependent services, an intended service area can be broadcast. This intended service area can cover one or more NTN cells (i.e., serving cells and neighboring cells) or portions thereof. The geographical intended service area ID can indicate an MBS broadcast session that is broadcast in MCCH.

Additionally, according to an exemplary embodiment, the base station of the non-terrestrial network may utilize RRC signaling or DCI to transmit the service area information to the terminal. It may be appropriate for the base station of the non-terrestrial network to transmit the service area information in a manner that allows the terminal in the idle mode to receive information on MBS services, including broadcast services.

Meanwhile, according to an exemplary embodiment of the present disclosure, schemes for delivering the service area information to the terminal may include using an MCCH or providing the information through a new or existing SIB.

Specifically, regarding a level of detail of the service area information, it may be possible to provide the complete detailed information, including a service area identifier and detailed information of each area. Alternatively, according to an implementation example of the present disclosure, only the service area identifier may be included, and the detailed information may be provided through a user service description (USD) or a new SIB.

In this regard, considering the limited payload size of the existing SIB20 (e.g. 2976 bits), providing the information through the MCCH may be more appropriate to integrate and deliver the complete detailed information. In particular, since SIB20 currently does not include MBS session identifiers, whereas the MCCH includes this information, the MCCH may be more suitable considering that the service area identifier needs to be associated with the MBS session identifier. However, this is not limited thereto.

Additionally, according to an exemplary embodiment of the present disclosure, to optimize MCCH monitoring when the terminal is not located within any service area, the following schemes may be applied. Specifically, as a first scheme, a service area update may be indicated via an MCCH modification notification in DCI. In this case, if the terminal is not located within service areas of broadcast services it is configured to receive, the terminal may re-acquire the MCCH only when the MCCH modification notification DCI indicates an update to the service area(s).

Alternatively, as a second scheme, a longer modification periodicity may be applied for service area changes of broadcast services. For example, the service area modification periodicity may be set as a multiple of an MCCH modification periodicity. In this case, if the terminal is not located within any service area, the terminal may not need to re-acquire the MCCH within the service area modification period.

According to an embodiment of the present disclosure, MCCH can provide a list of all broadcast services with ongoing sessions transmitted on MTCH. As related information for the broadcast session, it may include the MBS session ID, associated G-RNTI scheduling information, one or more intended service area IDs in the case of NTN broadcast, and information about neighboring cells providing certain services on MTCH.

The MCCH content is transmitted within periodically occurring time domain windows, referred to as the MCCH transmission window. The MCCH transmission window may be defined by the MCCH repetition period, MCCH window duration, and radio frame/slot offset.

Therefore, it may be preferable for the base station of the non-terrestrial network to broadcast the service area information to the terminal via RRC signaling. For example, the base station of the non-terrestrial network may deliver the service area information to the terminal using system information that includes service area details.

For example, the base station may include the service area information in an already established existing SIB by reflecting the service area details. Additionally, according to an exemplary embodiment of the present disclosure, the service area information may be required in various aspects, such as SIB20 (for determining whether to acquire MCCH), MBS broadcast configuration information (for determining whether to monitor an MBS traffic channel (MTCH)), and SIB21 (for service continuity).

According to an embodiment of the present disclosure, SIB may include a list of intended service areas for MBS broadcast reception along with related pointers. Specifically, SIB contains a description of the intended service area for the broadcast service of an NTN cell. If intended service areas are defined for MBS broadcast, they are broadcast as a list in SIB. Meanwhile, the UE requirements related to the contents of SIB do not exist separately, except for the requirements specified within the procedures that use the relevant system information and/or the requirements specified in the corresponding field descriptions.

In this regard, the service area may be represented as a set of reference points and radii or a set of polygons, which may cause significant signaling overhead and do not need to be repeated in multiple places. Accordingly, according to an exemplary embodiment of the present disclosure, the service area information may be defined in a new SIB or an existing SIB20, and an area identifier may be assigned to each area. This allows locations requiring service area information to simply reference the corresponding area identifier, thereby significantly reducing signaling overhead.

Specifically, according to an exemplary embodiment, the existing SIBs used to deliver service area information may include at least one of SIB1, SIB6, SIB7, SIB19, SIB20, and SIB25, but are not limited thereto.

For example, SIB20 may provide a database of service areas for all broadcast service sessions. Considering a case where SIB20 always provides service area information for broadcast service sessions 1, 2, and 3, at a time T0, the MCCH may include the broadcast service sessions 1 and 2; at a time T1, it may include the broadcast service session 1; and at a time T2, it may include the broadcast service sessions 2 and 3.

With this design, SIB20 may remain unchanged regardless of addition or release of broadcast services. However, since it may be burdensome for the RAN node to maintain service area information for all broadcast service sessions not activated in the cell, an approach may be considered where SIB20 is updated only when a new broadcast service starts (e.g. when MSB(s) in the MCCH modification notification of the MBS DCI indicates addition of a session), adding the service area of the newly added broadcast service session to the list.

In this regard, according to an exemplary embodiment of the present disclosure, two methods may be considered to optimize MCCH monitoring when the terminal is not located within any service area. The first method involves indicating a service area update through an MCCH modification notification DCI, while the second method applies a longer modification period for service area changes in the broadcast service.

Specifically, in the first method, when the terminal is not located within any of the service areas of the broadcast services it is set to receive, it may reacquire the MCCH only if the MCCH modification notification DCI indicates an update to the service area. On the other hand, in the second method, the service area update period can be set as a multiple of the MCCH modification period. In this case, if the terminal is not located within any service area, it may not need to reacquire the MCCH within the service area update period.

According to an exemplary embodiment of the present disclosure, the service area information may be understood as having a relatively static characteristic. Considering this characteristic, SIB20 may function as a database for the service areas of all broadcast service sessions supported by the RAN node.

This design has the advantage that SIB20 can remain unchanged even if the MCCH includes different broadcast service sessions at various times. However, as a compromise, an approach may be considered where SIB20 is updated only when a new broadcast service starts, such as when the MSB in the MCCH modification notification indicates the addition of a session.

According to this scheme, the terminal may operate as follows based on its situation. First, a terminal configured to receive a temporary mobile group identifier (TMGI) without a service area will follow the existing MCCH acquisition procedure. A terminal configured to receive a TMGI #1 but not located within the corresponding service area may not perform MCCH acquisition. A terminal configured to receive a TMGI #3 and located within the corresponding service area may selectively perform MCCH acquisition and re-acquisition.

In another example, the base station may deliver service area information to the terminal by defining a new SIB that includes the service area information. In other words, the service area information may be included in an SIB, which may be incorporated into an existing SIB or defined as a new SIB. In summary, the base station may use Options 1 to 3 to deliver service area information to the terminal. Option 1 may be a scheme of extending an existing SIB or existing MCCH. Option 2 may be a scheme of defining a new SIB. Option 3 may be a hybrid scheme combining Options 1 and 2. In this case, considering the limited available bits in the existing SIB or MCCH, it may be preferable to apply Option 2 or Option 3 compared to Option 1, though this is not limited thereto.

According to an exemplary embodiment of the present disclosure, considering the predictability of service area information and the update cycle in relation to MBS broadcast services, the service area information may be provided through a new SIB. Specifically, this approach minimizes the impact of the intended service area (ISA) information on existing UEs and has the advantage of alleviating MCCH acquisition when the terminal is located outside all defined ISAs.

Additionally, according to an exemplary embodiment of the present disclosure, the ISA identifier of an MBS service may be selectively included in service announcement. Through this, the terminal may recognize the ISA identifier of a specific MBS broadcast service of interest and combine the information from the new SIB and the service announcement to alleviate MCCH acquisition. Specifically, by including the ISA identifier in the service announcement, the terminal may determine whether it is within the ISA of the MBS service of interest and, when alleviating MCCH acquisition, consider only the relevant area.

Meanwhile, a terminal interested in the MBS service may skip MCCH acquisition when it is located outside the intended service area of the service. Specifically, depending on implementation, the terminal may determine whether to skip MCCH acquisition by utilizing its location, the ISA definition in the SIB/USD, and the mapping information between the ISA ID in the USD/service announcement and the MBS service ID (TMGI).

Furthermore, according to an exemplary embodiment of the present disclosure, in a quasi-earth fixed cell, information regarding the MBS broadcast configuration and service of the next satellite scheduled to serve the area may be provided. Through this, the terminal may prevent service interruptions caused by satellite changes and reduce signaling overhead. Specifically, the serving cell may signal a list of the next satellites/cells scheduled to provide the same MBS service, and this information may be provided along with satellite support information included in another system information block (e.g. SIB19). Such signaling may include information on a time, frequency, or PCI when the next satellite starts serving the intended service area associated with the current cell or MBS service.

For reference, according to an exemplary embodiment of the present disclosure, a service area identifier (ISA ID) may be represented using an index in the service area list. Specifically, instead of assigning a separate ISA ID, the ISA may be indicated using an index value of the service area within the service area list. This scheme has the advantage of efficiently indicating the service area without requiring additional identifier assignment.

Meanwhile, according to an exemplary embodiment of the present disclosure, since service area information has a relatively semi-static characteristic, frequent updates may not occur. Considering this characteristic, updates to service area information in the new SIB may follow the existing SIB modification procedure. By reusing the existing SIB modification procedure, the service area information may be efficiently updated without a need to define a new update mechanism. Additionally, as service area information has a semi-static characteristic, issues related to the MCCH update cycle may also be minimized.

According to an exemplary embodiment of the present disclosure, two scheme may be considered for indicating service area information: a scheme using an index within a list and a scheme using a unique identifier (ID). The index-based scheme has advantages such as small data size and a simple search mechanism but may have the drawback of being dependent on list order and not ensuring global uniqueness.

In contrast, the ID-based scheme allows for stable referencing, enhances global uniqueness and readability, but may result in relatively larger data size and additional management overhead. Particularly in the EMC environment, where the service area information list may be frequently updated and where service area information may be provided through both AS signaling and NAS signaling, the ID-based scheme may be more effective.

For example, the geographical information on the service area included in the SIB may include reference location information at a reference time based on epoch time within NTN configuration information (e.g. NTN-config), distance information from the reference point.

Meanwhile, when service area information including multiple areas is provided, the SIB can additionally include the following information.
MBS Area Identifier List (e.g. MBS-AreaIDlist)
MBS Area Identifier (e.g. MBS-AreaID)

This information may be specifically included in the following SIBs in relation to existing MBS.
Added to the sparel field in MCCH MessageType r17
Added to the existing mbsBroadcastConfiguration to form a new mbsBroadcastConfiguration (e.g. mbsBroadcastConfiguration-r19).
Added to the sparel field in MulticastMCCH MessageType r18.
Added to the existing mbsMulticastConfiguration to form a new mbsMulticastConfiguration (e.g. mbsMulticastConfiguration-r19).

For this purpose, the following service area information may be added to each mbsSessionInfoList within MBSBroadcastConfiguration and MBSMulticastConfiguration.
Reference location information at a reference time based on epoch time within NTN configuration information (e.g. NTN-config).
Distance information from the reference location.

Additionally, when the service area is provided through multiple regions, the following information can also be included:
MBS Area Identifier List (e.g. MBS-AreaIDlist)
MBS Area Identifier (e.g. MBS-AreaID)

This information may also be added to the MBS interest indication message (e.g. MBSInterestIndication message) for each MBS service list (e.g. mbsServiceList) and may be included in a similar manner.

Furthermore, the proposed MBS service area information may be defined per MBS service list (e.g. mbsServiceList) or per MBS session information list (e.g. mbsSessionInfoList). The MBS service area information may be indicated by defining a new SIB using the list indicators of the above messages.

Meanwhile, according to an exemplary embodiment of the present disclosure, a transmission unit of an MBS service may be determined based on a coverage of a satellite beam. For example, when a service area is smaller than a satellite footprint, particularly in the case of a single satellite beam or multiple satellite beams, it may be difficult to implement a broadcast-based service only within the actual intended service area. Accordingly, the minimum transmission unit for broadcasting may be configured based on the coverage of the satellite beam.

In order to provide service area information, according to an exemplary embodiment of the present disclosure, a new information element, IntendedServiceAreaInfo-r19, may be defined as follows.

```
IntendedServiceAreaInfo-r19 ::= SEQUENCE
  intendedServiceAreaId-r19 IntendedServiceAreaId-r19,
  intendedServiceArea-ReferenceLocation-r19 ReferenceLocation-r17,
  intendedServiceArea-DistanceRadius-r19 INTEGER(0..65536)
}
```

Meanwhile, MBSBroadcastConfiguration-r19-IEs may be configured as shown in Table 4 below.

TABLE 4

```
MBSBroadcastConfiguration-r17 ::= SEQUENCE {
      criticalExtensions CHOICE {
          mbsBroadcastConfiguration-r17  MBSBroadcastConfiguration-r17-IEs,
          criticalExtensionsFuture  SEQUENCE { }
        }
      }
MBSBroadcastConfiguration-r17-IEs ::= SEQUENCE {
        mbs-SessionInfoList-r17 MBS-SessionInfoList-r17
OPTIONAL, -- Need R
        mbs-NeighbourCellList-r17 MBS-NeighbourCellList-r17
OPTIONAL, -- Need S
        drx-ConfigPTM-List-r17 SEQUENCE (SIZE (1..maxNrofDRX-
ConfigPTM-r17)) OF DRX-ConfigPTM-r17 OPTIONAL, -- Need R
        pdsch-ConfigMTCH-r17 PDSCH-ConfigBroadcast-r17
OPTIONAL, -- Need S
        mtch-SSB-MappingWindowList-r17 MTCH-SSB-MappingWindowList-r17
OPTIONAL, -- Need R
        lateNonCriticalExtension OCTET STRING
OPTIONAL,
        nonCriticalExtension MBSBroadcastConfiguration-r19-IEsSEQUENCE
{ } OPTIONAL
      }
MBSBroadcastConfiguration-r19-IEs ::= SEQUENCE {
        mbs-SessionAreaMapping-r19 MBS-SessionAreaMapping-r19
OPTIONAL, -- Need R
        nonCriticalExtension SEQUENCE { }
OPTIONAL
      }
MBS-SessionAreaMapping-r19 ::= SEQUENCE {
        mbs-SessionId-r19  TMGI-r17,
        mbs-AreaInfoList-r19  SEQUENCE (SIZE (1..maxNrofMBS-
SessionPerArea-r19)) OF MBS-IntendedAreaID-r19
      }
      MBS-IntendedAreaID-r19 ::= INTEGER (0..maxNrofMBS-Area-r19)
      -- TAG-MBSBROADCASTCONFIGURATION-STOP
      -- ASN1STOP
```

Additionally, according to an embodiment of the present disclosure, the newly introduced SIB-related message may be configured as shown in Table 5 below.

TABLE 5

```
        -- ASN1START
        -- TAG-SIBXX-START
SIBXX-r19 ::= SEQUENCE {
        intendedServiceAreaList-r19 IntendedServiceAreaList-r19 OPTIONAL, --
Need R
        lateNonCriticalExtension OCTET STRING OPTIONAL,
        ...
      }
IntendedServiceAreaList-r19 ::= SEQUENCE (SIZE (1.. maxNrofMBS-Area-r19)) OF
IntendedServiceAreaInfo-r19
IntendedServiceAreaInfo-r19 ::= SEQUENCE {
        intendedServiceAreaId-r18 MBS-IntendedAreaID-r19,
        areaCoordinates-r19 CHOICE {
          polygonArea OCTET STRING,
          circleArea SEQUENCE {
            referenceLocation-r19 ReferenceLocation-r17,
            distanceRadius-r19 INTEGER(0..65535)
          }
        }
      }
      -- TAG-SIBXX-STOP
      -- ASN1STOP
```

The defined message structure, field configuration, parameters, and sequence described above are based on an embodiment of the present disclosure. However, those skilled in the art will understand that various modifications and implementations may be made without departing from the technical spirit or essential features of the present disclosure.

Next, a more detailed explanation of each message field defined above is provided as follows:
polygonArea within IntendedServiceAreaInfo-r19 may be defined using the polygon parameter type specified in TS 37.355. In this case, the first/leftmost bit contains the most significant bit.
intendedServiceAreaList-r19 within SIBXX-r19 represents a list of intended service areas and includes detailed information about each intended service area.
mbs-SessionAreaMapping-r19 within MBSBroadcastConfiguration-r19-IEs provides a mapping relationship between an MBS session and the geographical area where that session is serviced. Each MBS session may be associated with one or more intended service areas.
pdsch-ConfigMTCH provides parameters for acquiring PDSCH for MTCH. If this field is absent, the UE uses the parameters in pdsch-ConfigMCCH to acquire PDSCH for MTCH.
mbs-SessionInfoList provides the configuration of each MBS session delivered via MBS broadcast in the current cell.
mbs-NeighbourCellList provides a list of neighboring cells that deliver one or more MBS broadcast services via broadcast MRB in the current cell. This field is used in conjunction with the mtch-NeighbourCell field, which is signaled in the corresponding MBS-SessionInfo for each MBS session.

If an empty list is signaled, the UE assumes that the MBS broadcast service signaled in the mbs-SessionInfoList of the MBSBroadcastConfiguration message is not provided by any neighboring cell.

If a non-empty list is signaled, the current serving cell does not provide information about MBS broadcast services in neighboring cells that are not included in mbs-NeighbourCellList. This means that the UE cannot determine the presence or absence of MBS services in missing neighboring cells.

If the mbs-NeighbourCellList field is absent, the current serving cell does not provide information about MBS broadcast services in neighboring cells. This means that the UE cannot determine the presence or absence of MBS services in neighboring cells based on the absence of this field.

Additionally, according to another exemplary embodiment of the present disclosure, a scheme utilizing a mapped cell identifier introduced in NTN Release 17 may be applied to provide service area information. Specifically, the network may broadcast the mapped cell identifier along with the corresponding area information and provide the association between the mapped cell identifier and the service area. This scheme may also be useful for the terminal to report an MBS interest indication on a mapped cell basis.

Furthermore, according to an exemplary embodiment of the present disclosure, service area information may be provided through a system information block (SIB). Specifically, the service area information may be provided through SIB1, which includes scheduling of all system information, or through SIB20 or SIB21, which includes MBS broadcast-related information. Additionally, the service area information may be provided through SIB6 or SIB7, which includes Earthquake and Tsunami Warning System (ETWS) notifications, or through SIB19, which includes satellite support information for NTN access. Considering the size and utilization of the service area information, defining a new SIB to provide this information may also be considered.

Meanwhile, since a temporary mobile group identity (TMGI) and a service area identifier (SAI) already include a mobile country code (MCC)) or a public land mobile network identifier (PLMN ID), no additional improvements may be necessary for handling different country information.

As another example, considering that MBS service area information is specialized for NTN, the service area information may additionally be included in SIB19. According to an exemplary embodiment, the service area information may be reflected in SIB20, SIB21, or MBS broadcast configuration (e.g. MBSBroadcastConfiguration) and may include the following details.
SIB20: information required to obtain MCCH/MTCH configuration for MBS broadcast
SIB21: mapping relationship between current and/or neighboring carrier frequencies and MBS frequency selection area identities (FSAIs).
MBS broadcast configuration (e.g. MBSBroadcastConfiguration): control information applicable to MBS broadcast services transmitted through broadcast MRBs.

When the aforementioned detailed information are provided through SIB20 or SIB21, the operation of the terminal may be optimized to avoid unnecessary tasks. For example, the details may be provided through SIB20, and in this case, the terminal may be located outside the valid range (service area) of the MBS service and may not receive unnecessary MBS broadcast configuration messages.

Conversely, when detailed information on the service area is provided through an MBS broadcast configuration message, MBS session ID information in the existing MBS broadcast configuration message may be reused to indicate the service area information of the valid range of the MBS service. Therefore, the base station may reduce signaling overhead related to the service area information.

In this regard, the MBS session ID information may not be included in the existing SIB20 and SIB21. Considering the original purposes of each SIB, providing service area information through MBS broadcast configuration messages may be more preferable for the base station. This may be because the service area information may be considered as a part of control information for providing an area-specific MBS broadcast service for each MBS session.

That is, according to an exemplary embodiment of the present disclosure, MBS-related information (e.g. the MBS session list, the intended broadcast service area, etc.) may be included in MBSBroadcastConfiguration within MCCH. Specifically, MCCH already includes the MBS broadcast session, scheduling information, and a list of neighboring cells providing the same MBS service, and the intended service area information may be provided within the existing MCCH structure.

Additionally, according to an exemplary embodiment of the present disclosure, a terminal located outside the intended service area may not reacquire MCCH. In the MCCH-based scheme, a notification may be transmitted through a PDCCH addressed with an MCCH RNTI, ensuring that only terminals interested in MBS receive the notification. Furthermore, whether a new service will be provided may be indicated using a single bit.

Meanwhile, according to an exemplary embodiment of the present disclosure, even if an NTN terminal can receive MBS services, MRB configuration may be restricted when the terminal is located outside the MBS service area. Moreover, while the terminal may release MRB when moving out of the intended service area, the release of MRB may also be determined based on additional conditions such as an elapsed time or distance after leaving the MBS area, as the terminal cannot permanently maintain MRB.

In this regard, according to an embodiment of the present disclosure, an NTN UE supporting MBS broadcast may initiate the broadcast MRB establishment procedure when it is inside the intended service area. Additionally, the UE may initiate the broadcast MRB release procedure when it moves outside the intended service area. However, depending on the implementation of the present disclosure, the network may not be able to completely prevent the UE from decoding service content when it is outside the intended service area.

Furthermore, according to an exemplary embodiment of the present disclosure, an NTN terminal may determine whether it is inside or outside the MBS service area based on GNSS positioning, which is also used for other NTN purposes. Thus, there is no need to update the terminal's GNSS position separately for this purpose.

Additionally, according to an exemplary embodiment of the present disclosure, ReferenceLocation-r17 and a corresponding list of radii may be introduced to indicate the service area. When representing the service area in a polygonal form, the number of vertices that need to be signaled for a single polygon and whether each vertex should be represented using a ReferenceLocation information element may be determined.

However, due to the size limitation of the MBS broadcast configuration message, it may be difficult for the base station to include all information representing the service areas in the MBS broadcast configuration message. In such a case, the base station may define a new SIB in a manner described below. Alternatively, an alternative approach, such as modifying an existing USD, may be considered. For example, the base station may define a new SIB that includes a list of service area IDs and service area details (reference point and radius) for each MBS service area ID. Alternatively, the base station may modify the USD to include the corresponding information.

Furthermore, according to an implementation example of the present disclosure, the base station may include only information related to mapping between MBS session IDs and intended service area IDs in the MBS broadcast configuration message. Subsequently, the base station may define a new SIB to include service area details (reference point and radius) for each MBS intended service area ID. Alternatively, the base station may apply a scheme of modifying the USD.

According to one exemplary embodiment of the present disclosure, service area information may include non-geographical information for modeling each of multiple service areas. Specifically, according to an exemplary embodiment of the present disclosure, the non-geographical information included in the service area information may be defined using at least one of a beam index, a mapped cell ID, a tracking area identifier (TAI), a service ID, a TMGI, a session ID, a G-RNTI, an MRB, or a synchronization signal block (SSB), which are associated with each MBS service.

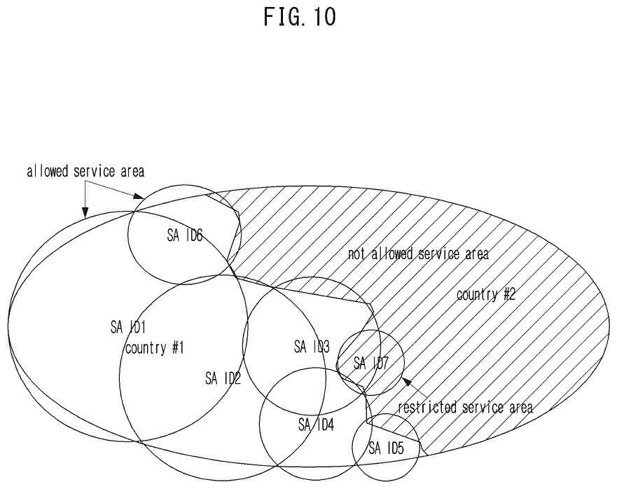

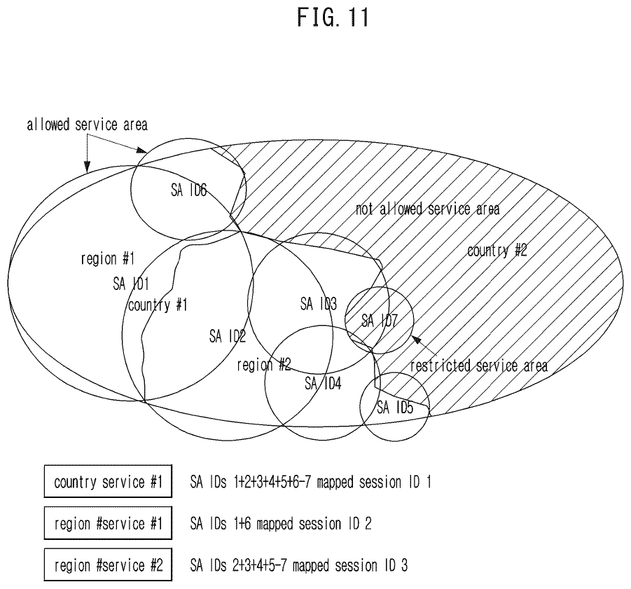

FIG. 10 is a conceptual diagram illustrating exemplary embodiments of service areas classified into allowed service areas and restricted areas.

Referring to FIG. 10, geographical information for distinguishing between allowed service areas and restricted service areas may be defined through coordinates of reference points for center positions of each service area (SA) and distance (radius, diameter) information of circularly shaped service areas by utilizing the format of SIB25 for signaling TN coverage in NTN. This approach may be useful for representing various forms of intended service areas through NW implementation, and by individually defining circularly shaped service areas corresponding to allowed service areas and restricted service areas, the shape of the intended service area may be approximated more accurately. To achieve this, service area information may include a list of MBS area IDs and MBS area information (reference point and distance from the reference point) corresponding to each MBS area ID. In FIG. 10, service areas may be distinguished by service area identifiers 1 to 7 and may be distributed across the country #1 and country #2. Here, a service area 1 (SA ID1) through a service area 6 (SA ID6) may be allowed service areas, and a service area 7 (SA ID7) may be a restricted service area.

FIG. 11 is a conceptual diagram illustrating exemplary embodiments of a method for associating service area information with MBS services.

Referring to FIG. 11, service area information may be provided through a new SIB. The service area information may be associated with session information linked to the corresponding broadcast service (MBS service). For this purpose, various types of identification information for the broadcast service session (e.g. session ID, TGMI, G-RNTI, etc.) may be considered. The service area information regarding the service area intended to be provided by each MBS service may need to include at least MBS service identification information, an MBS area ID corresponding to the MBS service identification information, and detailed area information (geographical information) corresponding to each MBS area ID.

According to an exemplary embodiment of the present disclosure, for associating the service area information with the MBS session, a first scheme in which one service area identifier is mapped to multiple MBS session identifiers, and a second scheme in which multiple service area identifiers are mapped to one MBS session identifier may be considered.

In this case, from the perspective of providing flexibility to configure independent service areas for each MBS session, the second scheme may be preferred. This many-to-one (N-to-1) mapping may be used to uniquely identify a service area-specific portion of an MBS service within the 5G core network but is not limited thereto.

Meanwhile, according to an implementation of the present disclosure, a terminal may receive MBS services even when located outside the service area. Specifically, the MBS broadcast service transmitted by the base station may be available throughout the entire cell area, and restricting MBS broadcast access outside the intended service area may not be necessary.

In this regard, according to an exemplary embodiment of the present disclosure, regarding frequency selection for MBS services, a terminal may operate as follows. During the cell reselection evaluation process, when the terminal is located within a geographical area associated with an MBS service that the terminal is interested in or currently receiving, the terminal may prioritize the corresponding frequency. For example, when the USD provides multiple frequencies for a service that the terminal is interested in, the terminal may more easily determine which frequency to select based on the association with the geographical service area information.

Additionally, according to an exemplary embodiment of the present disclosure, the MBS broadcast service area may be provided similarly to a TN coverage area list. Specifically, it may be provided in form of a list of reference locations and the corresponding cell radii.

Furthermore, regarding the terminal's recognition of the frequency for the service of interest, the terminal may perform frequency-to-MBS broadcast service mapping using existing procedures (e.g. SIB21 or USD). Before receiving the MBS broadcast service, the terminal needs to be aware of the frequency for the service of interest, and such frequency information may be obtained from SIB21 or USD. Therefore, it may be sufficient to map the provided geographical area to one or more MBS broadcast service frequencies.

Meanwhile, the service area information regarding the valid range of the MBS service disclosed in the present disclosure may be used for the following purposes. First, the service area information may be used to support location-dependent broadcast services within a part of an NTN cell or multiple NTN cells. Next, the service area information may be used to prevent unnecessary terminal operations that involve receiving MBS-related SI and/or MBS sessions outside the valid range (service area) of the MBS service.

In relation to the first purpose, the location-dependent broadcast services may distribute different content data for different MBS service areas. To support such location-dependent broadcast services, similarly to existing MBS mechanisms, a specific portion of a service area of the MBS service may be uniquely identified within the 5GC by using an identifier (ID) for service area information, which is composed of a reference point (reference location) and a radius within a part of an NTN cell or multiple NTN cells, together with the MBS session identifier (ID).

In this regard, to associate with the MBS session, the service area information may be associated with the MBS session ID according to methods from Option 1 to Option 2 as follows. First, the method of Option 1 may be a method that maps one service area ID to multiple corresponding MBS session IDs. The method of Option 2 may be a method that maps multiple service area IDs to one MBS session ID. In this case, Option 2 may be preferred from the perspective of providing flexibility to configure independent service areas for each MBS session but is not limited thereto.

In summary, a service area-specific portion of the MBS service may be uniquely identified within the 5GC by using the service area ID together with the MBS session ID to support location-dependent broadcast services, similarly to existing MBS mechanisms. In this case, multiple service area IDs may be mapped to one MBS session ID to associate the service area with the MBS session. In this regard, the base station may provide the following information to the terminal through one or more SIBs to indicate the details of the service area information regarding the valid range of the MBS service associated with the MBS session ID.
A list of MBS session IDs
A list of service area IDs for the valid range of the MBS service corresponding to each MBS session ID
Details of the service area for each intended service area ID of the MBS service (reference point and radius information included in the service area information)

Hereinafter, techniques for achieving service continuity related to MBS services will be described.

According to an exemplary embodiment of the present disclosure, the following schemes may be applied to ensure MBS service continuity. As a first scheme, SIB21 may introduce intended service area information (e.g. intended service area ID) associated with the current and/or neighboring carrier frequencies. As a second scheme, intended service area information associated with neighboring cells, as indicated in MCCH, may be utilized.

In this regard, according to an exemplary embodiment of the present disclosure, an MBS-capable terminal may only receive MBS broadcast services on a specific frequency. To ensure this, the terminal may prioritize a specific frequency by considering the following conditions. A first condition may be that SIB20 is expected to be included in scheduling information of a SIB1 of a cell reselected by the terminal due to frequency prioritization by MBS. A second condition may be that one or more MBS FSAIs of the frequency are indicated in the serving cell's SIB21, and the same MBS FSAIs are also indicated in the MBS USD for the MBS broadcast service, as specified in TS 26.517, that even if SIB21 is not provided in the serving cell, the frequency is included in the USD for the service, or that even if SIB21 is provided in the serving cell but does not specify frequency mapping for the service, the frequency needs to be included in the USD for the service.

Additionally, according to an exemplary embodiment of the present disclosure, if an MBS-capable terminal is receiving an MBS broadcast service or has a configuration prepared for reception, the terminal may assign the lowest priority to any candidate reselection frequency that does not allow MBS broadcast service reception, as long as SIB20 is included in the SIB1 scheduling information of the monitored MBS frequency cell and the aforementioned second condition is satisfied for the serving cell.

Meanwhile, considering that SIB21 includes a mapping relationship between the current and/or neighboring carrier frequencies and MBS FSAIs, the existing mechanism for ensuring MBS service continuity may assume that an MBS service area is mapped to one or more cells. However, in an NTN system, even if the two aforementioned conditions are met, the mechanism may not function effectively because the MBS intended service area of the frequency may not include the intended service area of the MBS session that the terminal is receiving or interested in, causing the terminal to deprioritize that frequency.

To address this issue, according to an exemplary embodiment of the present disclosure, a new mapping relationship between the current and/or neighboring carrier frequencies and MBS intended service area IDs may be defined. A list of carrier frequencies and the MBS intended service area ID list for each carrier frequency may be included in SIB21.

As another example, existing conditions for a terminal to perform MBS broadcast service cell reselection may be updated based on service area information regarding the valid coverage of the MBS service. Specifically, in addition to the two existing conditions, a third condition may be added: at least one MBS service area ID indicating the valid coverage of the frequency needs to be included in the serving cell's SIB21, and the MBS service area ID indicating the valid coverage of the same MBS service also needs to be indicated for the MBS broadcast service session.

According to an exemplary embodiment of the present disclosure, MBS service continuity may be considered from the following two aspects. As a first aspect, the serving base station may indicate a list of neighboring cells that provide the same MBS broadcast service on a MCCH, through which the terminal may request unicast reception of the corresponding service before moving to a cell that does not provide the MBS broadcast service based on PTM transmission.

As a second aspect, the NR MBS may support MBS frequency layer prioritization for MBS broadcast sessions, where the base stations provide MBS frequency service area (MBS FSA) identifiers supported on each frequency, which may include both the same frequency and different frequencies.

The following two conditions may be satisfied during an MBS broadcast session. An MBS broadcast-capable terminal may receive the MBS broadcast service. Alternatively, the MBS broadcast-capable terminal may be interested in receiving the MBS broadcast service. The MBS broadcast-capable terminal may receive the MBS broadcast service only by camping on a frequency that provides the corresponding MBS broadcast service. In such a case, the terminal may consider the corresponding frequency as the highest priority.

The first condition may be that SIB20 is included in scheduling information of SIB1 of a cell reselected by the terminal due to MBS-based frequency prioritization. The second condition is satisfied if any of the following apply.
One or more MBS FSAIs of the corresponding frequency may be indicated in SIB21 of the serving cell, and the same MBS FSAI is also indicated in an MBS USD of the MBS broadcast service.
SIB21 may not be provided in the serving cell, and the corresponding frequency is included in the USD of the service.
SIB21 is provided in the serving cell but may not provide frequency mapping for the corresponding service, and the corresponding frequency is included in the USD of the service.

Additionally, the MBS broadcast-capable terminal may be able to receive the MBS broadcast service. Alternatively, the MBS broadcast-capable terminal may be interested in receiving the MBS broadcast service. In such a case, SIB20 may be included in scheduling information of SIB1 of the cell of the MBS frequency monitored by the terminal, and the aforementioned second condition may be satisfied for the serving cell. The terminal may consider the reselection candidate frequencies of cells that cannot receive the MBS broadcast service during the MBS broadcast session as the lowest priority.

Meanwhile, SIB21 may include mapping relationships between the current and/or neighboring carrier frequencies and MBS FSAIs. Considering this, it may be assumed that the MBS service area is mapped to one or more cells in the existing mechanisms for MBS service continuity. In the NTN system, the aforementioned first and second conditions may be satisfied. In such a situation, the intended MBS service area of the corresponding frequency may not include the intended service area of the MBS session receivable by the terminal. Alternatively, the intended MBS service area of the corresponding frequency may not include the intended service area of the MBS session in which the terminal is interested. In such cases, the terminal may not consider the corresponding frequency as the highest priority, which may lead to ineffective operation.

Therefore, improvement of the existing mechanisms for MBS service continuity may be necessary. As an example, the present disclosure may define a new mapping relationship between the current and/or neighboring carrier frequencies and the intended MBS service area IDs, and the following information may be included in SIB21.
A list of carrier frequencies (already present in SIB21)
A list of intended MBS service area IDs for each carrier frequency

As another example, the existing conditions for terminal cell reselection for MBS broadcast services may be updated based on the service area information regarding the valid range of the MBS service as follows.
An MBS broadcast-capable terminal may receive the MBS broadcast service. Alternatively, the MBS broadcast-capable terminal may be interested in receiving the MBS broadcast service. The MBS broadcast-capable terminal may receive the MBS broadcast service by camping on a frequency that provides the MBS broadcast service. In such a case, the terminal may consider the corresponding frequency as the highest priority during the MBS broadcast session when the following three conditions (Condition 1 to Condition 3) are satisfied.

(Condition 1) SIB20 is included in scheduling information of SIB1 of a cell reselected by the terminal due to MBS-based frequency prioritization.

(Condition 2) One of the following is satisfied.
One or more MBS FSAIs of the corresponding frequency are indicated in SIB21 of the serving cell, and the same MBS FSAI is also indicated in the MBS User Service Description (USD) of the MBS broadcast service.
SIB21 is not provided in the serving cell, and the corresponding frequency is included in the USD of the service.
SIB21 is provided in the serving cell but does not provide frequency mapping for the corresponding service, and the corresponding frequency is included in the USD of the service.

(Condition 3) One or more service area IDs regarding the valid range of the MBS service for the corresponding frequency may be indicated in SIB21 of the serving cell. The same service area ID regarding the valid range of the MBS service may also be indicated for the MBS broadcast service session.

In other words, the two conditions of the existing mechanism may be satisfied in the NTN system. In such cases, the intended MBS service area of the corresponding frequency may not include the intended service area of the MBS session receivable by the terminal. Alternatively, the intended MBS service area of the corresponding frequency may not include the intended service area of the MBS session in which the terminal is interested. In such cases, the terminal may not prioritize the corresponding frequency. Therefore, the existing mechanism for MBS service continuity may not operate effectively.

The present disclosure may define a new mapping relationship between the current and/or neighboring carrier frequencies and the intended MBS service area IDs for the existing mechanism of MBS service continuity. Additionally, the present disclosure may include the relevant information in SIB21. Alternatively, the present disclosure may apply improvements to update the existing MBS service continuity mechanism for terminal cell reselection of MBS broadcast services based on the service area information regarding the valid range of the MBS service.

According to an exemplary embodiment of the present disclosure, SIB21 may be utilized during the terminal's cell reselection procedure to ensure service continuity of MBS sessions, through which the terminal can prioritize MBS frequencies that provide the MBS sessions configured for reception. In this regard, as service areas are provided for each MBS frequency through SIB21, the terminal may accurately identify the service area that provides the MBS session configured to be received on a specific frequency.

Accordingly, the terminal may operate to treat the corresponding MBS frequency as the highest priority during cell reselection based on its location and the service area information for each MBS frequency. Additionally, regarding the association between the service area and the MBS session, a first scheme in which a frequency service area identifier (FSAI) is associated with one MBS broadcast session, and a second scheme in which one FSAI (i.e. FSAI #x) is associated with multiple MBS broadcast sessions may be applied.

In the case of the first scheme, since one FSAI is clearly associated with one MBS broadcast session, there is an advantage of simply providing the service area through each FSAI. In contrast, in the case of the second scheme, MBS broadcast session for each FSAI and its corresponding service area may need to be clearly indicated.

According to an exemplary embodiment of the present disclosure, regarding the association between the MBS session and the service area, the serving base station may provide the associated service area within neighboring cells for each broadcast service session in the neighbor cell configuration. Through this, the terminal may identify the service area information of the neighboring cells in advance and may request unicast reception, before moving to a cell that does not provide the MBS broadcast service based on PTM transmission.

Additionally, in the case of cell reselection, the terminal may need to determine the frequency priority based on whether the MBS broadcast service configured for reception is provided by the corresponding frequency at the current location. Specifically, the service area of the MBS broadcast service provided for each frequency may be provided through SIB21, and the terminal may dynamically determine frequency priority based thereon.

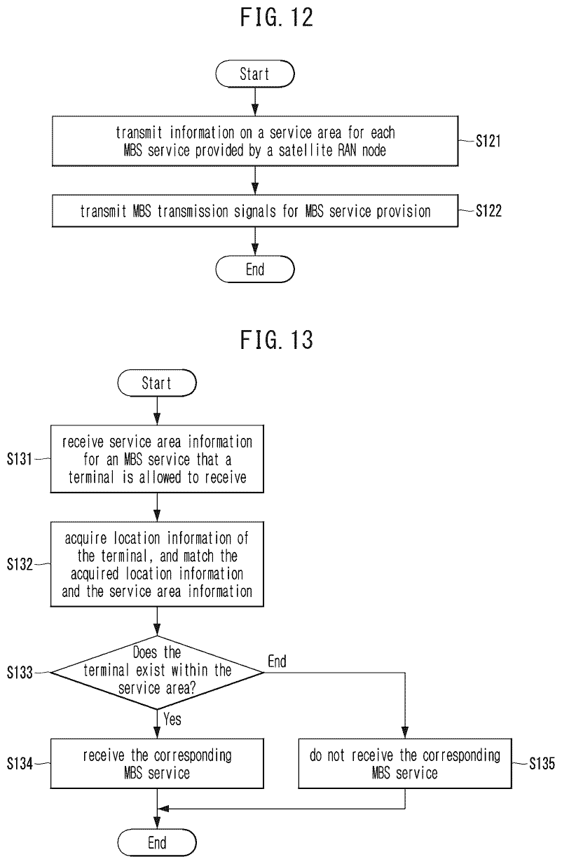

FIG. 12 is a flowchart illustrating exemplary embodiments of a method for providing multicast and broadcast services in a non-terrestrial network by a base station.

Referring to FIG. 12, in step S121, the base station may transmit service area information, including information regarding a valid range of an MBS service, to the terminal for each of multiple pre-configured service areas where the MBS service is provided. Then, in step S122, the base station may transmit MBS transmission signals for MBS service provision to the terminal.

In the above description, steps S121 to S122 may be further divided into additional steps or combined into fewer steps depending on the implementation of the present disclosure. Additionally, some steps may be omitted as needed, and the order of the steps may be changed. The method of the non-terrestrial network base station illustrated in FIG. 12 may be performed by the base station described earlier. Therefore, even omitted details regarding the base station may be equally applied to the description of FIG. 12.

FIG. 13 is a flowchart illustrating exemplary embodiments of a method for providing multicast and broadcast services in a non-terrestrial network by a terminal.

Referring to FIG. 13, in step S131, the terminal may receive service area information, including information regarding the valid range of the MBS service, from the base station of the non-terrestrial network. Then, in step S132, the terminal may acquire location information of the terminal and match the acquired location information with the received service area information.

Meanwhile, according to an exemplary embodiment of the present disclosure, in step S132, the base station or terminal may verify the location of the terminal to check the accuracy of the terminal's location information (e.g. country area ID or random access-RNTI (RA-RNTI)). Through this, the base station may identify cases where the location reported by the terminal is not trustworthy (e.g. if the terminal previously provided false information or if the terminal is in a state of high mobility). In such cases, the base station may trigger network-based location determination and location information.

In this regard, when the terminal accesses the network, the NTN base station may identify the country area ID and/or RA-RNTI of the terminal. If the network or base station trusts the country area ID and/or RA-RNTI, the network or base station may approve the terminal's access. Conversely, if the network or base station does not trust the terminal's country area ID and/or RA-RNTI, the network or base station may estimate the actual location of the terminal. Based on the estimation, if the country area ID and/or RA-RNTI of the terminal is accurate, the network or base station may allow access of the terminal. Otherwise, the network or base station may block access of the terminal.

Meanwhile, a timer may be used to perform the trust verification. For example, the terminal may use the correct country area ID or RA-RNTI. In such a case, the network or base station may set a trust period during which the country area ID or RA-RNTI reported by the terminal is trusted as valid, based on past information (e.g. the terminal's location, speed, class, etc.). The network or base station may treat the location information of the terminal reported before the expiration of the timer as valid. For example, timer values may be set smaller for terminals located near a border compared to terminals located deep inside the border.

Next, in step S133, the terminal may determine whether the terminal is located within the corresponding service area. In other words, in step S133, the terminal may verify whether it is located within the corresponding service area based on its location information. If the determination result in step S133 indicates that the terminal is located within the service area, in step S134, the terminal may receive the MBS service from the base station using the MBS transmission signals associated with the corresponding service area information.

Conversely, if the determination result in step S133 indicates that the terminal is located outside the service area (in other words, if the location information does not match the service area information), in step S135, the terminal may block the MBS service associated with the corresponding service area information. In this regard, according to an exemplary embodiment of the present disclosure, in step S135, the terminal may receive the MBS transmission signals associated with the corresponding service area information from the base station. The terminal may block the MBS service by not performing decoding of the MBS transmission signals.

According to another exemplary embodiment of the present disclosure, in step S135, the terminal may block the MBS service by not receiving the MBS transmission signals associated with the corresponding service area information from the base station. In this regard, some location-dependent broadcast services may need to be accessed only within areas allowed in different cities and/or countries due to various MBS service frameworks (e.g. regulations, billing, etc.). In the TN system, the network or base station may not impose restrictions on the terminal's operation regarding service reception. Additionally, the network or base station may control MBS service accessibility by identifying a list of accessible cells or tracking areas.

In the case of NTN, location-dependent MBS service areas may exist within specific areas of an NTN cell. Therefore, unless improvements such as network verification of the terminal's location and service area-specific group ID assignment are introduced, the existing mechanisms may not function effectively in the NTN network. Accordingly, to effectively manage service accessibility based on the terminal's geographical location, the following terminal operations related to MBS service reception may be defined.

Specifically, the terminal may receive service area information for the MBS broadcast service, and the terminal may have a valid identifier to receive the corresponding service. In such a case, if the terminal is outside the service area, access to the corresponding service may be restricted.

Meanwhile, according to an exemplary embodiment of the present disclosure, the terminal may perform different operations depending on the following cases. For example, if the terminal is configured to receive a TMGI that does not have a service area, the terminal may follow the existing MCCH acquisition procedure.

In another example, if the terminal is configured to receive only TMGI #1 but is not located within the service area of the corresponding TMGI, the terminal may not need to perform MCCH acquisition. In yet another example, if the terminal is configured to receive TMGI #3 and is located within the corresponding service area, the terminal may perform MCCH acquisition and reacquisition at times T0 and T2, but may not perform them at a time T1.

In the above description, steps S131 to S135 may be further divided into additional steps or combined into fewer steps depending on the implementation of the present disclosure. Additionally, some steps may be omitted as needed, and the order of the steps may be changed. The method for providing multicast and broadcast services in the non-terrestrial network by the terminal illustrated in FIG. 13 may be performed by the terminal described earlier. Therefore, even omitted details regarding the terminal may be equally applied to the description of FIG. 13.

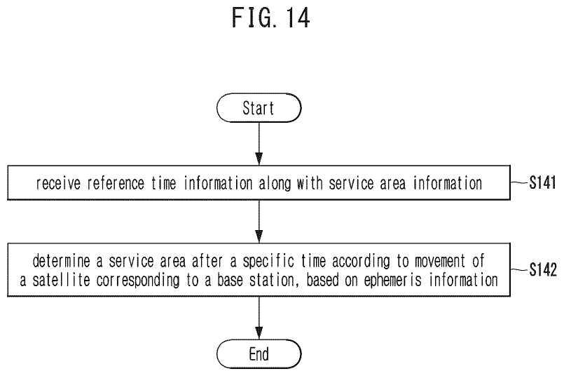

FIG. 14 is a flowchart illustrating exemplary embodiments of a method for providing multicast and broadcast services in a non-terrestrial network by a terminal.

Referring to FIG. 14, when a base station forms an earth-moving cell, the base station may transmit reference time information for the corresponding service area along with the service area information to the terminal. When the base station forms an earth-moving cell as described, in step S141, the terminal may receive the reference time information for the corresponding service area along with the service area information.

Then, in step S142, the terminal may calculate service area information after a certain period based on movement of a satellite corresponding to the base station, using ephemeris information obtained from sources such as SIB19.

In the above description, steps S141 to S142 may be further divided into additional steps or combined into fewer steps depending on the implementation of the present disclosure. Additionally, some steps may be omitted as needed, and the order of the steps may be changed.

The method for receiving MBS services using the service area information of the terrestrial moving cell illustrated in FIG. 14 may be performed by the terminal described earlier. Therefore, even omitted details regarding the terminal may be equally applied to the description of FIG. 14.

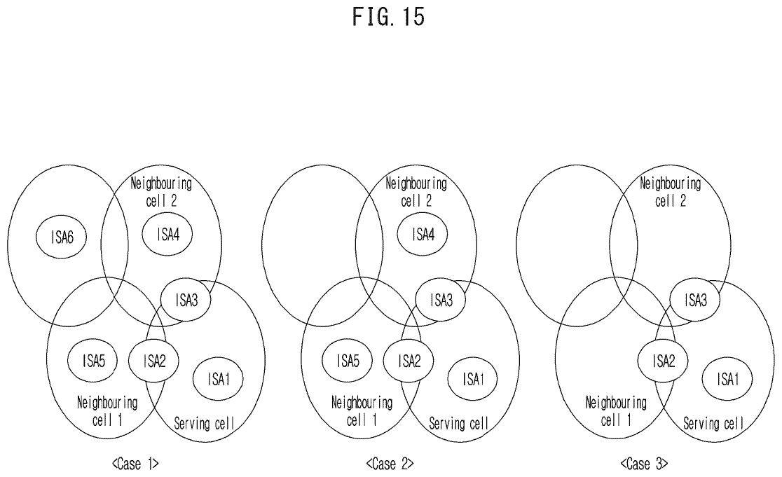

FIG. 15 is a conceptual diagram illustrating examples of the range of a list of intended service areas signaled in a certain cell.

Referring to FIG. 15, the following three options may be considered for the range of a list of intended service areas that should be signaled via the new SIB in a given cell.
Option 1 (case 1): The list of intend service areas covers the entire geographical areas set by network.
Option 2 (case 2): The list of intended service areas covers the geographic areas within the serving cell and all neighboring cells.
Option 3 (case 3): The list of intended service areas covers the geographic areas within the serving cell and only the areas across the serving cell and overlapping neighbour cells.
If Option 1 is selected, the list of intended service areas does not need to be frequently updated, even in an EMC (Earth Moving Cell) scenario. This allows the intended service areas to be referenced easily via an index in the list. However, Option 1 requires high signalling overhead compared to other options.

If Option 2 or Option 3 is selected, the list of intended service areas may require frequent updates in an EMC scenario. This could introduce challenges in using an index in the list as a pointer due to potential list modifications. Option 3, while reducing signaling overhead, may not fully support the intend service area information for neighboring cells, impacting service continuity.

If the MBS broadcast capable UE is receiving or interested to receive an MBS broadcast service(s) and can only receive this MBS broadcast service(s) by camping on a frequency on which it is provided, the UE may consider that frequency to be the highest priority during the MBS broadcast session as long as the two following conditions are fulfilled:
1) SIB1 scheduling information of the cell reselected by the UE due to frequency prioritization for MBS contains SIB20;
2) Either:
   One or more MBS FSAI(s) of that frequency is indicated in SIB21 of the serving cell and the same MBS FSAI(s) is also indicated for this MBS broadcast service in MBS User Service Description (USD), or
   SIB21 is not provided in the serving cell and that frequency is included in the USD of this service, or
   SIB21 is provided in the serving cell but does not provide the frequency mapping for the concerned service, and that frequency is included in the USD of this service.

If the MBS broadcast capable UE is receiving or interested to receive an MBS broadcast service, the UE may consider cell reselection candidate frequencies at which it cannot receive the MBS broadcast service to be of the lowest priority during the MBS broadcast session as long as SIB1 scheduling information of the cell contains SIB20 on the MBS frequency which the UE monitors and as long as the condition 2) above is fulfilled for the serving cell.

In an NTN environment, a UE supporting MBS broadcast service may operate as follows:
For an MBS broadcast service intended for a certain area, an UE supporting the feature should not establish MRB(s) for the MBS session associated to the intended area when it is outside the intended area.
For an MBS broadcast service intended for a certain area, an UE supporting the feature may initiate the broadcast MRB establishment procedure when UE is inside the intended area; the UE may initiate the broadcast MRB release procedure when UE leaves the intended area.

Specially, the UE may consider that frequency of neighboring cell providing the interested MBS as the highest priority only if it will be within the intended service areas after cell reselection. Conversely, the UE should not assign the highest frequency to that frequency if it will be outside the intended service areas.

To address these issues, the following two options can be considered.
Option 1: To define a new mapping relationship between the current and/or neighbouring carrier frequencies and MBS intended service area IDs. This approach would involve modifying SIB21 to include:
   Carrier frequency list (already existing in SIB21)
   MBS intended service area ID(s) per each carrier frequency
Option 2: To utilize intended service area information of neighboring cells from a new SIB and MCCH. This approach would include:
   A list of intended service areas within each neighboring cell in a new SIB
   The intended service area IDs of neighboring cells in MCCH

In option 1, when the MBS broadcast capable UE is receiving or interested to receive an MBS broadcast service(S) and can only receive this MBS broadcast service(s) by camping on a frequency on which it is provided, the UE may consider that frequency to be the highest priority during the MBS broadcast session if the UE will be within the intended service areas corresponding to one or more intended service area ID(s) of that frequency indicated in SIB21. Conversely, the UE should not prioritize that frequency as the highest priority if it will be outside the intended service areas.

In option 2, the UE may consider that frequency as the highest priority during the MBS broadcast session if the UE will be within the intended service areas corresponding to one or more intended service ID(s) of neighbouring cells indicated in MCCH.

When an MBS broadcast capable UE is receiving or interested to receive an MBS broadcast service(S) and can only receive this MBS broadcast service(s) by camping on a frequency on which it is provided, the UE may consider that frequency as the highest priority during the MBS broadcast session only if it will be only within the intended service areas.

When an MBS broadcast capable UE is receiving or interested to receive an MBS broadcast service(S) and can only receive this MBS broadcast service(s) by camping on a frequency on which it is provided, the UE should not consider that frequency as the highest priority during the MBS broadcast session if the UE will be outside the intended service areas.

For service continuity, one of the following options should be selected:
Introduce intended service area information (e.g., intended service area ID(s)) associated with the current and/or neighboring carrier frequencies in SIB21.
Utilize intended service area information associated with neighboring cells, as provided in MCCH.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a non-terrestrial network (NTN) base station, comprising:
transmitting, to a terminal, service area information including information on a valid range of a multicast-broadcast service (MBS) for each of a plurality of service areas preconfigured for MBS provision; and
transmitting MBS signals for providing the MBS to the terminal.

2. The method according to claim 1, wherein the service area information includes geographic information indicating a shape of each of the plurality of service areas.

3. The method according to claim 2, wherein at least one service area among the plurality of service areas has a circular shape, and the geographic information for the at least one service area includes information on a reference point of the circular shape and distance information from the reference point.

4. The method according to claim 2, wherein at least one service area among the plurality of service areas has an elliptical shape or a polygonal shape.

5. The method according to claim 1, wherein the service area information includes non-geographic information for modeling each of the plurality of service areas.

6. The method according to claim 5, wherein the non-geographic information includes at least one of a beam index associated with the MBS service, a cell identifier mapped to the MBS service, a tracking area identifier (TAI) associated with the MBS service, a service identifier associated with the MBS service, a temporary mobile group identity (TMGI) associated with the MBS service, a session identifier associated with the MBS service, a group radio network temporary identifier (G-RNTI) associated with the MBS service, an MBS radio bearer (MRB) associated with the MBS service, or a synchronization signal block (SSB) associated with the MBS service.

7. The method according to claim 1, wherein the service area information includes information on an allowed service area for the MBS service and information on a restricted service area for the MBS service.

8. The method according to claim 1, wherein the transmitting of the service area information to the terminal comprises:
generating system information including the service area information; and
transmitting the system information to the terminal to deliver the service area information to the terminal.

9. The method according to claim 8, wherein the system information is at least one of a system information block (SIB) 1, SIB6, SIB7, SIB19, SIB20 or SIB25.

10. The method according to claim 1, wherein a size of a transmission range of the MBS signals is larger than a size of a service area corresponding to the service area information.

11. The method according to claim 1, further comprising, when the NTN base station operates an earth-moving cell, transmitting information on a reference time for each of the plurality of service areas.

12. A method of a terminal, comprising:
receiving, from a non-terrestrial network (NTN) base station, service area information including information on a valid range of a multicast-broadcast service (MBS);
acquiring a location of the terminal;
identifying a service area matching the location based on the service area information; and
in response to identifying a service area matching the location, selectively receiving the MBS from the NTN base station by receiving MBS signals associated with the identified service area.

13. The method according to claim 12, further comprising: in response to not identifying a service area matching the location, not receiving the MBS service.

14. The method according to claim 12, further comprising:
in response to not identifying a service area matching the location, receiving the MBS signals; and
not performing decoding of the MBS signals.

15. The method according to claim 12, further comprising:
receiving information on a reference time for each of a plurality of service areas from the NTN base station; and
determining a service area after a specific time according to satellite movement using ephemeris information of the NTN base station and the information on the reference time.

16. The method according to claim 15, wherein the selectively receiving of the MBS comprises:
in response to the location being matched to the service area information, starting a multicast radio bearer (MRB) establishment procedure; and
in response to the location not being matched to the service area information, releasing an established MRB.

17. A terminal comprising at least one processor, wherein the at least one processor causes the terminal to perform:
receiving, from a non-terrestrial network (NTN) base station, service area information including information on a valid range of a multicast-broadcast service (MBS);
acquiring a location of the terminal;
identifying a service area matching the location based on the service area information; and
in response to identifying a service area matching the location, selectively receiving the MBS from the NTN base station by receiving MBS signals associated with the identified service area.

18. The terminal according to claim 17, wherein the at least one processor further causes the terminal to perform: in response to not identifying a service area matching the location, not receiving the MBS service.

19. The terminal according to claim 17, wherein the at least one processor further causes the terminal to perform:
in response to not identifying a service area matching the location, receiving the MBS signals; and
not performing decoding of the MBS signals.

20. The terminal according to claim 17, wherein the at least one processor further causes the terminal to perform:
receiving information on a reference time for each of a plurality of service areas from the NTN base station; and
determining a service area after a specific time according to satellite movement using ephemeris information of the NTN base station and the information on the reference time.
